(19) United States
(12) Patent Application Publication
(10) Pub. No.: US 2025/0271684 A1
(43) Pub. Date: Aug. 28, 2025

(54) HEAD-UP DISPLAY DEVICE AND METHOD OF CONTROLLING HEAD-UP DISPLAY DEVICE

(71) Applicant: Nippon Seiki Co., Ltd., Niigata (JP)

(72) Inventors: Yuji Inosaka, Niigata (JP); Yukihisa Hoshi, Niigata (JP); Yuri Sato, Niigata (JP)

(21) Appl. No.: 19/037,058

(22) Filed: Jan. 24, 2025

(30) Foreign Application Priority Data
Feb. 26, 2024 (JP) 2024-026158

(51) Int. Cl. G02B 27/28; G02B 27/01

(52) U.S. Cl. CPC G02B 27/286; G02B 27/0101; G02B 2027/0118; G02B 2207/101

(57) ABSTRACT

A head-up display device including a backlight; a display; a polarization control element; an imaging optical system making first display light of a first polarization condition from an emission port via a first optical path having a first optical length to form a virtual image, and making second display light of a second polarization condition from the emission port via a second optical path having a second optical length longer than the first optical length to form a real image; and a controller controlling the polarization conditions of the display light and turning on and off of each light source. The controller performs control such that an area of the light sources turned-on more strongly than a predetermined intensity when the real image is displayed is made larger than an area of the light sources to be turned-on more strongly than a predetermined intensity when the virtual image is displayed.

### TECHNICAL FIELD

The present disclosure relates to a head-up display device which emits display light from an emission port toward a projection member so as to allow virtual and real images of a display image represented by the display light to be visually recognized, and also relates to a method of controlling the head-up display device.

### BACKGROUND ART

For example, Japanese Patent Application No. 2023-148856 (Patent Document 1 (PD1)), not yet been published at the time of filing the present application, describes a head-up display device that is provided with: an imaging optical system that includes a polarized reflective member with different transmittance (reflectance) depending on polarization conditions and a second reflective member for reflecting display light transmitted through the polarized reflective member, wherein the display light of a first polarization condition is emitted via a first optical path to be reflected on a surface of the polarized reflective member to form a virtual image and the display light of a second polarization condition is emitted via a second optical path to be transmitted through the polarized reflective member and reflected on the second reflective member to form a real image; and a single-system picture generation unit (PGU) disposed at a position inside a first focus of the imaging optical system in the first optical path and outside a second focus of the imaging optical system in the second optical path and switching between the first and second polarization conditions.

### PRIOR ART DOCUMENT

### Patent Document

Patent Document 1: Japanese Patent Application No. 2023-148856

### SUMMARY OF INVENTION

### Technical Problem

In the art described in PD1, for example, among the display lights (pixel lights) emitted from a single pixel of the PGU, pixel light emitted in a first direction is formed as the real image, and pixel light emitted in a second direction is formed as the virtual image.

In other words, when either one of the real image and the virtual image is displayed, the light emitted from the pixel in the direction for displaying the other image is useless and light utilization efficiency is thereby degraded.

FIGS. 15A and 15B depict irradiation directions (emission directions from a single pixel) of lights of light sources 214 at the time of displaying the virtual image and displaying the real image, respectively. In FIGS. 15A and 15B, symbol “L1” indicates a wide-ranging light ray area irradiated on a display 212 from light sources 214 mounted on a light-source circuit board 240 at the time of displaying the virtual image, and symbol “L2” indicates a wide-ranging light ray area irradiated on the display 212 from the light sources 214 mounted on the light-source circuit board 240 at the time of displaying the real image, in which the areas are surrounded by and illustrated with dash-dot lines. In a typical head-up display device, since it is sufficient that an image can be visually recognized at an eye box, the direction of light from a backlight (the direction of light emitted from a pixel) is restricted and thereby a backlight configuration bright and less wasteful at the eye box is realized. However, in a case where the virtual image and the real image are displayed, it is necessary to emit light in a wide range (e.g., directions A, B, C, and D) from a single pixel.

In a case where the real image is displayed, the wide-ranging light emitted from the single pixel is divided into light in a range visually recognized as the real image at the eye box (e.g., in FIG. 15B, light irradiated on the display 212 in a direction indicated by a solid arrow) and light in a range not visually recognized as the real image (e.g., in FIG. 15B, lights C and D indicated by broken lines, in which the light C is irradiated perpendicularly on the display 212 and thus useless and the light D is irradiated outwardly on the display 212 and thus useless). On the other hand, in a case where the virtual image is displayed, the wide-ranging light emitted from the single pixel is divided into light in a range visually recognized as the virtual image at the eye box (e.g., in FIG. 15A, light irradiated on the display 212 in a direction indicated by a solid arrow) and light in a range not visually recognized as the virtual image (e.g., in FIG. 15A, lights A, C, and D indicated by broken lines, in which the light A is irradiated inwardly on the display 212 and thus useless, the light C is irradiated perpendicularly on the display 212 and thus useless, and the light D is irradiated outwardly on the display 212 and thus useless). It is known that an outer edge part of a light source region (light-source circuit board 240), in which the light sources 214 are mounted, is likely to generate the light A that is visually recognized as the real image but not visually recognized as the virtual image.

In view of the above circumstances, the object of the present disclosure is to provide a head-up display device having a configuration for regulating the arrangement of light sources in a light source region, which are turned on when displaying the real image and when displaying the virtual image, and thereby suppressing a disadvantage such that, when either one of the real image and the virtual image is displayed, light emitted from a pixel in a direction for displaying the other image is useless, and improving light utilization efficiency, and also to provide a method of controlling the head-up display device.

Other objects of the present disclosure will become apparent to those skilled in the art by referring to the following exemplary aspects and best mode of exemplary embodiments as well as the accompanying drawings.

### Solution to Problem

Hereinafter, in order to easily understand the outline of the present disclosure, aspects according to the present disclosure will be exemplified.

A first aspect is a head-up display device provided with an emission port and emitting display light from the emission port toward a projection member so as to allow virtual and real images of a display image represented by the display light to be visually recognized, in which the head-up display device includes: a backlight that includes a plurality of light sources mounted thereon; a display that transmits illumination light emitted from the light sources and generates the display light; a polarization control element that switches between polarization conditions of the display light; an imaging optical system that causes first display light of a first polarization condition to be emitted from the emission port via a first optical path having a first optical path-length to form the virtual image, and causes second display light of a second polarization condition to be emitted from the emission port via a second optical path having a second optical path-length longer than the first optical path-length to form the real image; and a controller that controls the polarization conditions of the display light switched by the polarization control element and turning on and off of each of the light sources, wherein the controller performs control such that an area of the light sources to be turned-on more strongly than a predetermined intensity when the real image is to be displayed is larger than an area of the light sources to be turned-on more strongly than a predetermined intensity when the virtual image is displayed.

In this connection, the “predetermined intensity” refers to an emission intensity of light, set in a default state, that is emitted from the backlight provided with the light sources mounted thereon to the display when the virtual image or real image is to be displayed, and in this aspect, the level of the emission intensity is controlled based on the area of the light sources to be turned on. Thus, when the real image is to be displayed, the control is performed in such a manner that the area of the light sources to be turned-on more strongly than the predetermined intensity becomes larger than the area of the light sources to be turned-on more strongly than the predetermined intensity for displaying the virtual image. In addition, the “area of the light sources to be turned-on” refers, as depicted in FIG. 8 for example, to a mount area of the light sources 14 to be turned-on (a turn-on area “A” upon generating virtual image, a turn-on area “B” upon generating real image) defined on the light-source circuit board 140 of the backlight 11, among the plurality of light sources 14 mounted on the light-source circuit board 140. In the first aspect, the controller performs the control such that, when the real image is to be displayed, the area of the light sources to be turned-on more strongly than a predetermined intensity is made larger than the area of the light sources to be turned-on more strongly than a predetermined intensity when the virtual image is displayed, and thus, for example, performing control such that, when the real image is displayed, the outer periphery of the light source region is turned on, whereas when the virtual image is displayed, the outer periphery of the light source region, which is not visually recognized as the virtual image, is turned off, makes it possible to eliminate a difference in brightness between the time of displaying the real image RI and the time of displaying the virtual image VI while suppressing the generation of useless light, and thus to improve light utilization efficiency. In this way, it is possible to suppress a disadvantage such that, when either one of the real image and the virtual image is displayed, light emitted from a pixel in a direction for displaying the other image is useless, and thus to improve the light utilization efficiency.

In a second aspect depending on the first aspect, the controller may further perform control such that, when the display image is changed so as to switch from the virtual image to the real image, a light source disposed at a mount region not overlapping with the display when viewing a light-source circuit board of the backlight from a normal direction, on which the light sources are mounted, is turned-on more strongly than the predetermined intensity.

In the second aspect, when the display image is changed so as to switch the virtual image to the real image, the controller performs control such that, as depicted in FIG. 7B for example, light sources 14 (light beams indicated by solid arrows in the drawing) disposed at a mount region (i.e., outer peripheries Y1, Y2 of a light-source circuit board 140) not overlapping with a display 12 when viewing the light-source circuit board 140 of a backlight 11 from a normal direction, on which the light sources 14 are mounted, are turned-on more strongly than the predetermined intensity, and thereby makes it possible to suppress a disadvantage such that, when either one of the real image and the virtual image (e.g., real image) is displayed, light emitted from a pixel in a direction for displaying the other image (e.g., virtual image) is useless, and to improve light utilization efficiency. Note that, in FIGS. 7A and 7B, a solid arrow indicates a light beam used for display, and a broken arrow indicates a light beam not used for display.

In a third aspect depending on the first aspect, the controller may perform control such that the area of the light sources mounted on a light-source circuit board of the backlight, which are to be turned-on more strongly than the predetermined intensity when the real image is to be displayed, is larger than the area of the light sources mounted on the light-source circuit board, which are turned-on more strongly than the predetermined intensity when the virtual image is displayed, along a long-side direction of a rectangular region of the display.

In the third aspect, the controller performs control such that, as depicted in FIG. 8 for example, the area of the light sources 14 mounted on the light-source circuit board 140 of the backlight (turn-on area “B” upon generating real image), which are to be turned-on more strongly than a predetermined intensity when the real image is to be displayed, is made larger than the area of the light sources mounted on the light-source circuit board 140 (turn-on area “A” upon generating virtual image), which are turned-on more strongly than a predetermined intensity when the virtual image is displayed, along the long-side direction “H” of the display 12. Alternatively, in the case of switching from a real image display to a virtual image display, control may be adopted such that, as depicted in FIG. 9 for example, the light sources 14 on outer peripheries in a short-side direction “V” (upper and lower rows) of the turn-on area “B” upon generating real image are turned off.

In a fourth aspect depending on the first aspect, the controller may perform control such that the area of the light sources mounted on a light-source circuit board of the backlight, which are to be turned-on more strongly than the predetermined intensity when the real image is to be displayed, is larger than the area of the light sources mounted on the light-source circuit board, which are turned-on more strongly than the predetermined intensity when the virtual image is displayed, along each of long-side and short-side directions of a rectangular region of the display.

In the fourth aspect, the controller performs control such that, as depicted in FIGS. 10A and 10B for example, the area of the light sources 14 mounted on the light-source circuit board 140 of the backlight 11 (turn-on area “B” upon generating real image), which are to be turned-on more strongly than the predetermined intensity when the real image is to be displayed, is made larger than the area of the light sources 14 mounted on the light-source circuit board 140 (turn-on area “A” upon generating virtual image), which are turned-on more strongly than the predetermined intensity when the virtual image is displayed, along each of the long-side direction “H” and short-side direction “V” of the display. Therefore, it is possible to suppress a disadvantage such that, when either one of the real image and the virtual image is displayed, light emitted from a pixel in a direction for displaying the other image is useless, and to improve light utilization efficiency. Not limited to the turning-on patterns of the light sources 14 depicted in FIGS. 10A and 10B, other control may be adopted such that: (1) all light sources 14 arranged on outer peripheries of the light-source circuit board 140 are turned off; (2) the light sources 14 arranged at one periphery are turned off; (3) one periphery of each of the long “H” and short “V” sides is turned off; (4) a part of the light sources 14 is turned off when displaying the real image and then the part of the light sources 14 turned-off for displaying the real image is turned on when displaying the virtual image, and so forth.

In a fifth aspect depending on the first aspect, the controller may perform control such that the area of the light sources mounted on a light-source circuit board of the backlight, which are to be turned-on more strongly than the predetermined intensity when the real image is to be displayed, is larger than the area of the light sources mounted on the light-source circuit board, which are turned-on more strongly than the predetermined intensity when the virtual image is displayed, along each of long-side and short-side directions of a rectangular region of the display, and that an increment of the area of the light sources made larger along the long-side direction is larger than an increment of the area of the light sources made larger along the short-side direction.

In the fifth aspect, the controller performs the control such that, as depicted in FIGS. 10A and 10B for example, when the real image is to be displayed, the area of the light sources 14 mounted on the light-source circuit board 140 of the backlight 11 (turn-on area “B” upon generating real image), which are to be turned-on more strongly than the predetermined intensity, is made larger than the area of the light sources 14 mounted on the light-source circuit board 140 (turn-on area “A” upon generating virtual image), which are turned-on more strongly than the predetermined intensity when the virtual image is displayed, along each of the long-side direction “H” and short-side direction “V” of the display 12, and that an increment of the area of the light sources made larger along the long-side direction H is larger than an increment of the area of the light sources made larger along the short-side direction V, and thereby makes it possible to suppress a disadvantage such that, when either one of the real image and the virtual image is displayed, light emitted from a pixel in a direction for displaying the other image is useless, and to more effectively improve light utilization efficiency.

A sixth aspect is a head-up display device provided with an emission port and emitting display light from the emission port toward a projection member so as to allow virtual and real images of a display image represented by the display light to be visually recognized, in which the head-up display device includes: a first backlight that includes a plurality of first light sources mounted thereon; a first display that transmits illumination light from the first light sources and generates first display light; a second backlight that includes a plurality of second light sources mounted thereon; a second display that transmits illumination light from the second light sources and generates second display light; an imaging optical system that causes the first display light to be emitted from the emission port via a first optical path having a first optical path-length to form the virtual image, and causes the second display light to be emitted from the emission port via a second optical path having a second optical path-length longer than the first optical path-length to form the real image; a first controller that controls turning on and off of each of the first light sources; and a second controller that controls turning on and off of each of the second light sources, wherein the first controller performs control such that the first light sources are turned-on more strongly than a predetermined intensity when the virtual image is to be displayed by the first display light, and wherein the second controller performs control such that an area of the light sources to be turned-on more strongly than a predetermined intensity when the real image is to be displayed by the second display light is larger than an area of the light sources to be turned-on more strongly than the predetermined intensity when the virtual image is displayed.

In the sixth aspect, the head-up display device that includes dual systems for generating virtual images and real images, each including the light sources of the backlight, the display and the controller, and shares the imaging optical system, has a configuration in which the first controller performs the control such that the first light sources are turned-on more strongly than a predetermined intensity when the virtual image is to be displayed by the first display light, and the second controller performs the control such that an area of the light sources to be turned-on more strongly than a predetermined intensity when the real image is to be displayed by the second display light is made larger than an area of the light sources to be turned-on more strongly than the predetermined intensity when the virtual image is displayed. Due to the above configuration, for example, performing control such that, when the real image is displayed, the outer periphery of a light source region is turned on, whereas when the virtual image is displayed, the outer periphery of the light source region, which is not visually recognized as the virtual image, is turned off, makes it possible to eliminate a difference in brightness between the time of displaying the real image and the time of displaying the virtual image while suppressing the generation of useless light, and thus to improve light utilization efficiency. In this way, it is possible to suppress a disadvantage such that, when either one of the real image and the virtual image is displayed, light emitted from a pixel in a direction for displaying the other image is useless, and thus to improve the light utilization efficiency.

A seventh aspect is a method of controlling a head-up display device including a backlight that includes a light-source circuit board provided with a plurality of light sources mounted thereon; a display that transmits illumination light from the light sources of the backlight and generates display light; a polarization control element that switches between polarization conditions of the display light; an imaging optical system that causes first display light of a first polarization condition to be emitted from an emission port via a first optical path having a first optical path-length to form a virtual image, and causes second display light of a second polarization condition to be emitted from the emission port via a second optical path having a second optical path-length longer than the first optical path-length to form a real image; and a controller that controls the polarization conditions of the display light switched by the polarization control element and turning on and off of each of the light sources of the backlight, in which the method includes: switching, by the controller, the imaging optical system from the first optical path to the second optical path to change a display image from the virtual image to the real image; and performing, by the controller, control such that an area of a light source region of the light sources mounted on the light-source circuit board, which are to be turned-on more strongly than a predetermined intensity when the real image is to be displayed, is larger than an area of a light source region of the light sources to be turned-on more strongly than a predetermined intensity when the virtual image is displayed.

In the seventh aspect, the controller executes a procedure (step) of performing the control such that, when the real image is to be displayed, the area of the light sources to be turned-on more strongly than the predetermined intensity is made larger than the area of the light sources to be turned-on more strongly than the predetermined intensity when displaying the virtual image. When executing the above procedure, the controller performs the control such that, for example, the outer periphery of the light source region is turned on when displaying the real image, and on the other hand, the outer periphery of the light source region, which is not visually recognized as the virtual image, is turned off when displaying the virtual image, so that it is possible to eliminate a difference in brightness between the time of displaying the real image and the time of displaying the virtual image while suppressing the generation of useless light, and thus to improve light utilization efficiency. In this way, it is possible to suppress a disadvantage such that, when either one of the real image and the virtual image is displayed, light emitted from a pixel in a direction for displaying the other image is useless, and thus to improve the light utilization efficiency.

An eighth aspect is a method of controlling a head-up display device provided with an emission port and emitting display light from the emission port toward a projection member so as to allow virtual and real images of a display image represented by the display light to be visually recognized, the head-up display device including a first backlight that includes a plurality of first light sources mounted thereon; a first display that transmits illumination light from the first light sources and generates first display light; a second backlight that includes a plurality of second light sources mounted thereon; a second display that transmits illumination light from the second light sources and generates second display light; an imaging optical system that causes the first display light to be emitted from the emission port via a first optical path having a first optical path-length to form the virtual image, and causes the second display light to be emitted from the emission port via a second optical path having a second optical path-length longer than the first optical path-length to form the real image; a first controller that controls turning on and off of each of the first light sources; and a second controller that controls turning on and off of each of the second light sources, in which the method includes: performing, by the first controller, control such that the first light sources are turned-on more strongly than a predetermined intensity when the virtual image is to be displayed by the first display light; and performing, by the second controller, control such that an area of the light sources to be turned-on more strongly than a predetermined intensity when the real image is to be displayed by the second display light is larger than an area of the light sources to be turned-on more strongly than the predetermined intensity when the virtual image is displayed.

In the eighth aspect, the head-up display device that is provided with dual systems for generating the virtual images and the real images, each including the light sources of the backlight, the display and the controller, and shares the imaging optical system, has a configuration for executing procedures (steps) in which the first controller performs the control such that the first light sources are turned-on more strongly than a predetermined intensity when the virtual image is to be displayed by the first display light, and the second controller performs the control such that an area of the light sources to be turned-on more strongly than a predetermined intensity when the real image is to be displayed by the second display light is made larger than an area of the light sources to be turned-on more strongly than the predetermined intensity when the virtual image is displayed. When executing the above procedure, the controller performs the control such that, for example, the outer periphery of the light source region is turned on when displaying the real image, and on the other hand, the outer periphery of the light source region, which is not visually recognized as the virtual image, is turned off when displaying the virtual image, so that it is possible to eliminate a difference in brightness between the time of displaying the real image and the time of displaying the virtual image while suppressing the generation of useless light, and thus to improve light utilization efficiency. In this way, it is possible to suppress a disadvantage such that, when either one of the real image and the virtual image is displayed, light emitted from a pixel in a direction for displaying the other image is useless, and thus to improve the light utilization efficiency.

Those skilled in the art will readily appreciate that the exemplary aspects according to the present disclosure may be further modified without departing from the spirit of the present disclosure.

### BRIEF DESCRIPTION OF DRAWINGS

FIG. 1 is a diagram depicting an exemplary configuration of a head-up display device according to a first embodiment of the present disclosure, which includes an imaging optical system at the time of displaying a virtual image.

FIG. 2 is a diagram depicting an exemplary configuration of the head-up display device according to the first embodiment of the present disclosure, which includes an imaging optical system at the time of displaying a real image.

FIGS. 3A and 3B are diagrams depicting an exemplary lens configuration and optical path, between a backlight and a display, in the head-up display device according to the first embodiment of the present disclosure when the virtual image is displayed.

FIGS. 4A and 4B are diagrams depicting an exemplary lens configuration and optical path, between a backlight and a display, in the head-up display device according to the first embodiment of the present disclosure when the real image is displayed.

FIG. 5 is a diagram depicting an exemplary configuration of a control system of the head-up display device according to the first embodiment of the present disclosure.

FIG. 6 is a flowchart depicting an exemplary operation of the control system of the head-up display device according to the first embodiment of the present disclosure.

FIGS. 7A and 7B are diagrams depicting irradiation directions of light beams from each of a plurality of light sources mounted on a light-source circuit board of the backlight when viewing the light sources from a normal direction, at the time of displaying the virtual image and the real image, respectively, in the head-up display device according to the first embodiment of the present disclosure.

FIG. 8 is a diagram depicting an example of a first light-source turning-on pattern of the light sources mounted on the backlight, at the time of displaying the virtual image and the real image in the head-up display device according to the first embodiment of the present disclosure.

FIG. 9 is a diagram depicting an example of a second light-source turning-on pattern of the light sources mounted on the backlight, at the time of displaying the virtual image and the real image in the head-up display device according to the first embodiment of the present disclosure.

FIGS. 10A and 10B are diagrams depicting an example of a third light-source turning-on pattern of the light sources mounted on the backlight, at the time of displaying the virtual image and the real image in the head-up display device according to the first embodiment of the present disclosure.

FIG. 11 is a diagram depicting an example of a fourth light-source turning-on pattern of the light sources mounted on the backlight, at the time of displaying the virtual image and the real image in the head-up display device according to the first embodiment of the present disclosure.

FIG. 12 is a diagram depicting an exemplary configuration of a head-up display device according to a second embodiment of the present disclosure, which includes an imaging optical system at the time of displaying a virtual image.

FIG. 13 is a diagram depicting an exemplary configuration of a control system of the head-up display device according to the second embodiment of the present disclosure.

FIG. 14 is a flowchart depicting an exemplary operation of the control system of the head-up display device according to the second embodiment of the present disclosure.

FIGS. 15A and 15B are reference diagrams explaining the irradiation directions of light from light sources, in which FIG. 15A depicts the case of displaying a virtual image and FIG. 15B depicts the case of displaying a real image.

### DESCRIPTION OF EMBODIMENTS

The best mode of exemplary embodiments described below is used for easy understanding of the present disclosure. Therefore, it should be noted by those skilled in the art that the present disclosure is not unduly limited by the embodiments described below.

### Configuration of First Embodiment

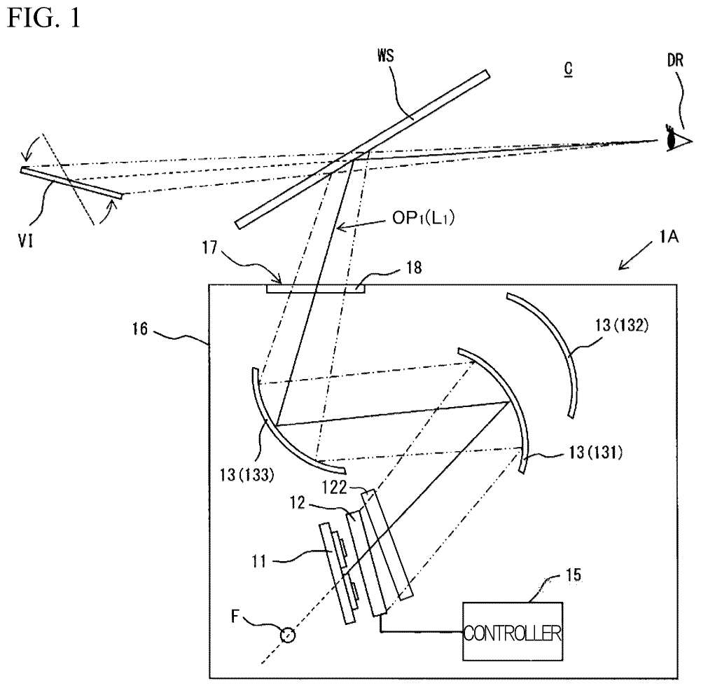

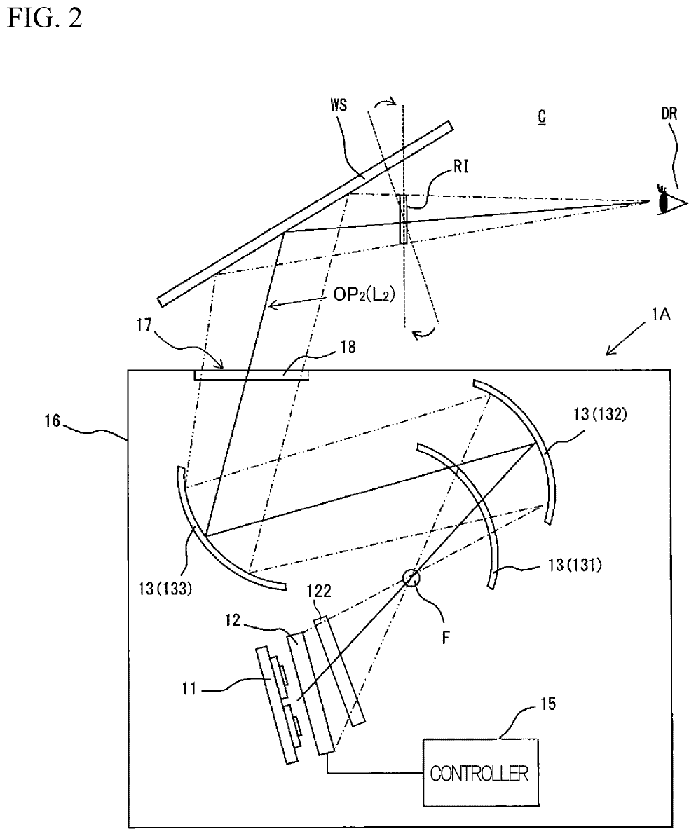

Hereinafter, a first embodiment of the present disclosure will be described with reference to the drawings. FIG. 1 is a diagram depicting a configuration in a case of generating a virtual image in a head-up display device (hereinafter, simply referred to as a HUD device 1A) according to the first embodiment, and FIG. 2 is a diagram depicting a configuration in a case of generating a real image.

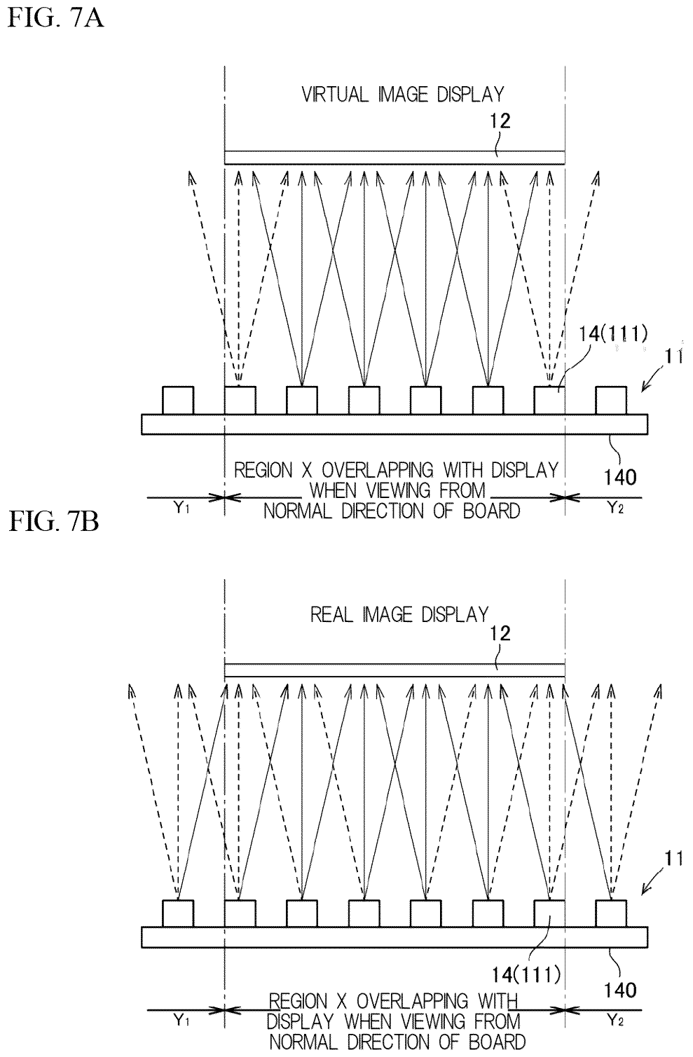

In FIGS. 1 and 2, the HUD device 1A includes, for example, a backlight 11 that includes light sources mounted thereon and emitting white light (see, e.g., “14” in FIGS. 7A and 7B), the light sources being light emitting diodes mounted on a light-source circuit board (see, e.g., “140” in FIGS. 7A and 7B) and emitting light in a visible wavelength range; a display 12 that generates an image based on incident light from the backlight 11 (light sources 14) and displays the image while switching the polarization of emission light between first polarization (a first polarization condition) and second polarization (a second polarization condition) different from each other; an imaging optical system 13 that includes a plurality of mirrors (reflective members) for reflecting display light “L” representing the image displayed on the display 12 (in FIG. 1, first display light L1 representing the display image of the virtual image VI, and in FIG. 2, second display light L2 representing the display image of the real image RI) toward a windshield WS as a projection member; and a controller 15 that performs control of the display contents of the display 12, switching control between the first and second polarizations, and control of turning on and off of the light sources 14 of the backlight 11. The backlight 11, the display 12, the imaging optical system 13, and the controller 15 are housed in a housing 16. The housing 16 is provided with an emission port 17 (opening) from which the display light L is emitted, and a cover glass 18 is disposed in the emission port 17 for protecting the interior of the housing.

The imaging optical system 13 causes the first display light L1 of the first polarization condition (first polarization) to be emitted from the emission port 17 via a first optical path OP1 having a first optical path-length to form the virtual image VI (FIG. 1), and causes the second display light L2 of the second polarization condition (second polarization) to be emitted from the emission port 17 via a second optical path having a second optical path-length longer than the first optical path-length to form the real image RI (FIG. 2). Thus, the imaging optical system 13 includes a first mirror 131, a second mirror 132, and a third mirror 133, each having a concave shape. The first mirror 131 reflects the first display light L1 as the first polarization, and transmits the second display light L2 as the second polarization. The second mirror 132 reflects the second display light L2 transmitted through the first mirror 131. The respective display lights (first display light L1 and second display light L2) reflected by the first mirror 131 and the second mirror 132 are guided to the third mirror 133, reflected by the third mirror 133, and emitted toward the windshield WS, so as to allow an occupant DR to visually recognize the respective display images.

Thus, the first optical path OP1 passes through the backlight 11 (light sources 14), the display 12, the first mirror 131, the third mirror 133, the emission port 17, and the windshield WS, while the second optical path OP2 passes through the backlight 11 (light sources 14), the display 12, the first mirror 131, the second mirror 132, the third mirror 133, the emission port 17, and the windshield WS, so as to ensure the visual recognition by the occupant DR. Therefore, the optical path-length of the second optical path OP2 is longer by the second mirror 132. Note that an infinite number of light beams are actually emitted from the display 12, but in FIGS. 1 and 2, a light beam emitted from the center of the display 12 and passing through the center of an eye box is depicted as a representative light beam by a symbol “L”, in order to simplify the description. In FIGS. 1, 2, 7A and 7B, the representative light beam emitted from the center of the display 12 is depicted by a solid line, a light beam emitted from a top end of the display 12 is depicted by a dash-dot line, and a light beam emitted from a bottom end of the display 12 is depicted by a dash-dot-dot line.

The HUD device 1A according to the first embodiment of the present disclosure is disposed below the windshield WS (e.g., inside an instrument panel) of the vehicle C, emits the display light L (first display light L1 and second display light L2), and projects the display light L on the windshield WS. The display light L is generated by the backlight 11 (light sources 14) and the display 12, both provided within the HUD device 1A. The display light L emitted from the display 12 travels along the imaging optical system 13 and is emitted from the emission port 17 of the housing 16 through the cover glass 18. The occupant DR in the vehicle C views the display light L reflected by the windshield WS, and thus is able to visually recognize the virtual image VI as depicted in FIG. 1 on the far side of the windshield WS and the real image RI as depicted in FIG. 2 on the near side of the windshield WS.

In the virtual image VI depicted in FIG. 1, information highly necessary to call attention to the occupant DR is displayed on the far side of the windshield WS as seen form the occupant DR, which includes, for example, vehicle information such as the speed or engine revs of the vehicle C, routing assistance such as turn-by-turn or a map, a blind spot indicator, a warning such as a speed limit excess warning, etc. As examples of the real image RI depicted in FIG. 2, entertainment contents, an assistant or agent supporting the occupant DR, a character indicating the assistant or agent, etc., are displayed on the near side of the windshield WS as seen from the occupant DR. Such display properties provide a driving environment with reduced need for viewpoint movement and eye focal-length adjustment. The virtual image VI and the real image RI also include a background part in addition to characters and icons indicating the above-described information, the background part having, e.g., a substantially rectangular shape in a plan view as seen from the occupant DR.

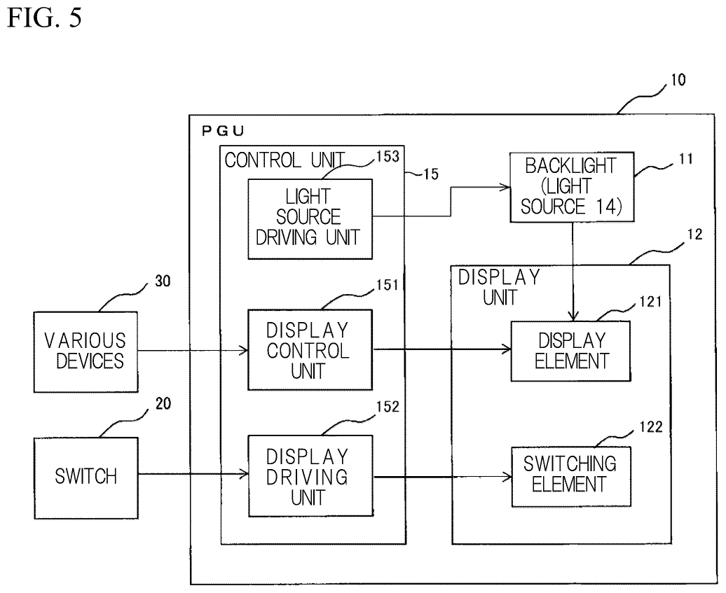

The display 12 includes, for example, a display element 121 of a thin film transistor (TFT) type (see FIG. 5), and a polarization control element 122 that is provided closer to the emission port 17 along the optical path than the display element 121 and switches the polarization of the emitted display light L between the first polarization and the second polarization different from each other. For example, the first polarization may be S-polarization and the second polarization may be P-polarization, or vice versa. Further, not limited to S or P-polarization, it is sufficient that the polarization angles of the first and second polarizations are different from each other, and it is preferable that, for example, the polarization angles are different from each other by at least 22.5 degrees.

As depicted in FIGS. 1 and 2, it is desirable that the display 12 is disposed to be inclined with respect to the axial direction (optical axis) of the light beam of the display light L, in order to exclude stray light (light leaking from the light sources 14 of the backlight 11) and external light (light entering from the outside) from the optical path of the display light L.

The display element 121 is connected to a display controller 151 as depicted in FIG. 5 described later, and forms light representing a graphic of an arbitrary shape in accordance with a signal sent from the display controller 151. The polarization control element 122 extracts only light beams with specific polarizations, more specifically, light beams with the above-described first or second polarizations, among light beams emitted from the display element 121, and performs control of switching the light beams. The polarization control element 122 is connected to a display driver 152 as depicted in FIG. 5 described later, and switches polarizations in accordance with a signal sent from the display driver 152.

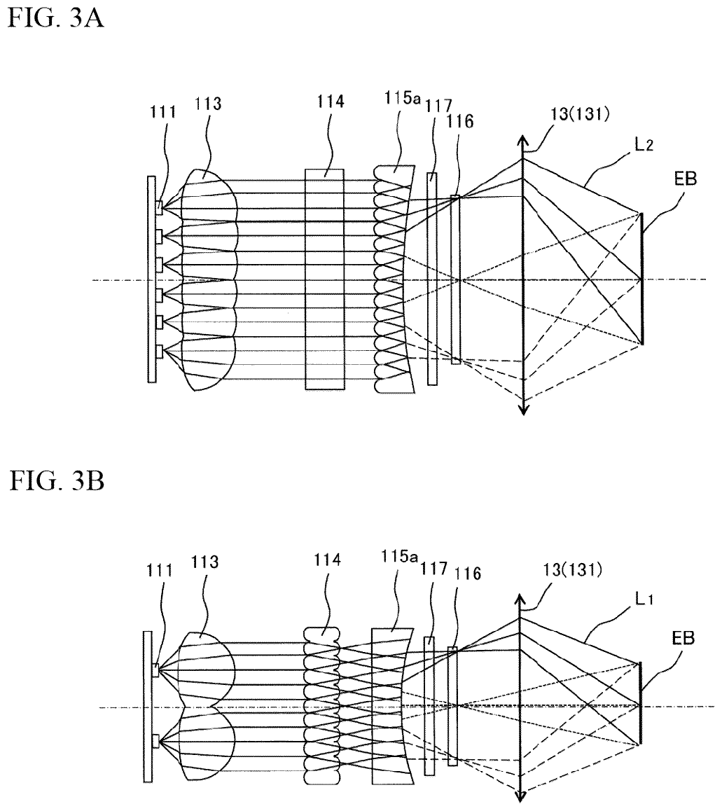

The switching of polarizations by the polarization control element 122 may be performed by electrical processing, or may be performed by using a polarizing plate (see “117” in FIGS. 3A and 3B described later) or a wave plate, that is disposed closer to the emission port 17 than the polarization control element 122, and physically rotating the plate at a predetermined angle with respect to a central axis defined along the direction of optical axis. In any case, the switching of polarizations is performed under the control of the display driver 152.

In this connection, such a configuration is considered that, for example, the first polarization is S-polarization (S-polarization with respect to the first mirror 131), the second polarization is P-polarization (P-polarization with respect to the first mirror 131), the first mirror 131 is a mirror that reflects a light beam of the said S-polarization to the first mirror 131 and transmits a light beam of the said P-polarization, and the second mirror 132 is a mirror that reflects a light beam of the said P-polarization to the first mirror 131 and transmits a light beam of the said S-polarization. In the above configuration, the first display light L1 with the S-polarization is reflected by the first mirror 131 and is guided to the third mirror 133. Also, the second display light L2 with the P-polarization is transmitted through the first mirror 131, is reflected by the second mirror 132, and is guided to the third mirror 133. By setting the configuration of the imaging optical system 13 and the polarizations of the display lights (the first display light L1 and the second display light L2) as described above, it is possible to generate display images different from each other by the display lights L1 and L2.

In FIG. 2, since the optical focus F is located closer to the emission port 17 than the first mirror 131, it is possible to display the real image RI at any appropriate positions in front of the occupant DR. In this connection, if the optical focus F is located closer to the display 12 than the first mirror 131, the optical focus F is being spaced from the second mirror 132, and the real image RI becomes displayed at a position gradually closer to the occupant DR in a larger size in accordance with spacing degrees, which makes the real image RI very difficult to view for the occupant DR. Thus, it is preferable that the optical focus F is near the second mirror 132, and in the HUD device 1A according to the first embodiment, the imaging optical system 13 is arranged in such a manner that the optical focus F is positioned at least between the first mirror 131 and the second mirror 132.

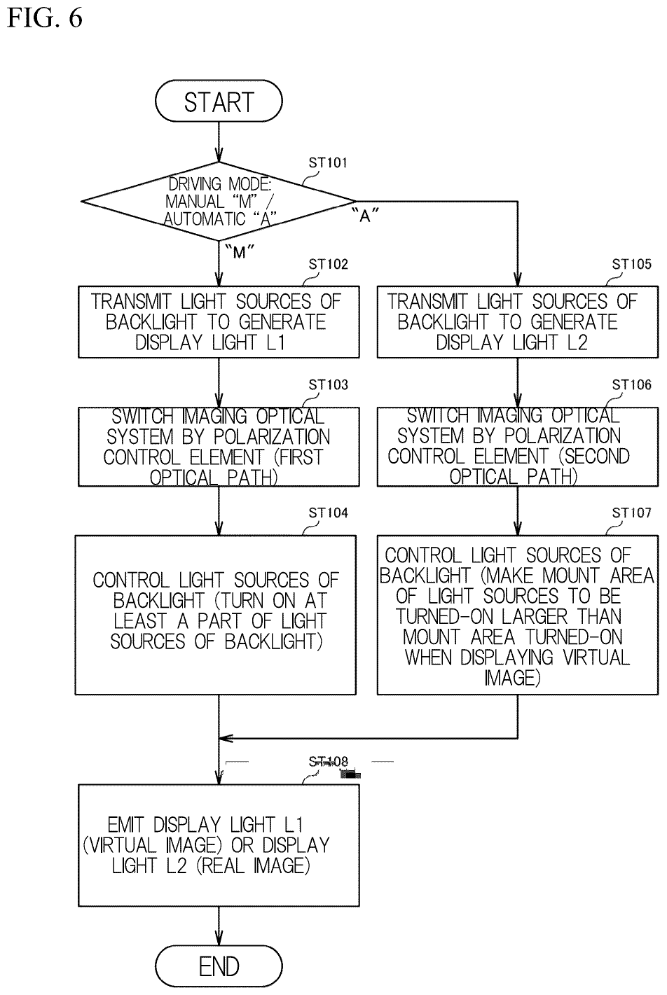

The controller 15 controls the polarization conditions of the display light L switched by the polarization control element 122 and the turning-on and off of each of the light sources 14. The controller 15 performs control such that an area of the light sources 14 to be turned-on more strongly than a predetermined intensity when the real image RI is to be displayed is made larger than an area of the light sources 14 turned-on more strongly than a predetermined intensity when the virtual image VI is displayed. The configuration and operation of the controller 15 will be described later with reference to FIGS. 5 and 6.

Reference is now made to FIGS. 3A and 3B. FIG. 3A depicts a lens configuration and optical path as viewed in H-direction, and FIG. 3B depicts a lens configuration and optical path as viewed in V-direction, at the time of displaying the virtual image VI. In FIGS. 3A and 3B, light emitted from LEDs 111 provided as the backlight 11 (light sources 14) comes into parallel light substantially parallel to an optical axis by a condenser lens 113, in both the H and V-directions. The light receiving surface of a first lenticular lens 114, on a side facing the LEDs 111, is structured in such a manner that a plurality of cylindrical lenses, each having a convex curved surface facing the LEDs 111 as viewed in a V-direction cross-section, are disposed side-by-side along the V-direction. The light emitting surface of the first lenticular lens 114 is structured in such a manner that a plurality of cylindrical lenses, each having a convex curved surface on a side emitting the second display light L2 as viewed in a V-direction cross-section, are disposed side-by-side along the V-direction. Due to the above structure, the first lenticular lens 114 condenses the light of the LEDs 111 in relation to the V-direction to form a multiple image.

The light receiving surface of a second lenticular lens 115, on a side facing the LEDs 111, is structured in such a manner that a plurality of cylindrical lenses, each having a convex curved surface facing the LEDs 111 as viewed in an H-direction cross-section, are disposed side-by-side along the H-direction. The light emitting surface of the second lenticular lens 115 is structured as a toroidal surface having a concave shape in both the V and H-directions. Due to the above structure, the second lenticular lens 115 condenses the light of the LEDs 111 in relation to the H-direction to form a multiple image, and aligns the direction of light with respect to the subsequent imaging optical system 13 (see FIGS. 1 and 2). The second lenticular lens 115 for displaying the virtual image VI is referred to as a first lens 115a.

The second display light L2 emitted from the first lens 115a is diffused by a diffuser plate 117 (not depicted in FIG. 1) to reduce uneven brightness, etc. The second display light L2 diffused by the diffuser plate 117 enters a liquid crystal panel (LCP) 116 provided as the display 12, generates an image in accordance with the control of a control board (the controller 15 in FIG. 1), and is emitted to the first mirror 131 of the subsequent imaging optical system 13. Due to the above lens configuration and optical path, the occupant DR is able to visually recognize the virtual image VI with appropriate luminance and uniformity.

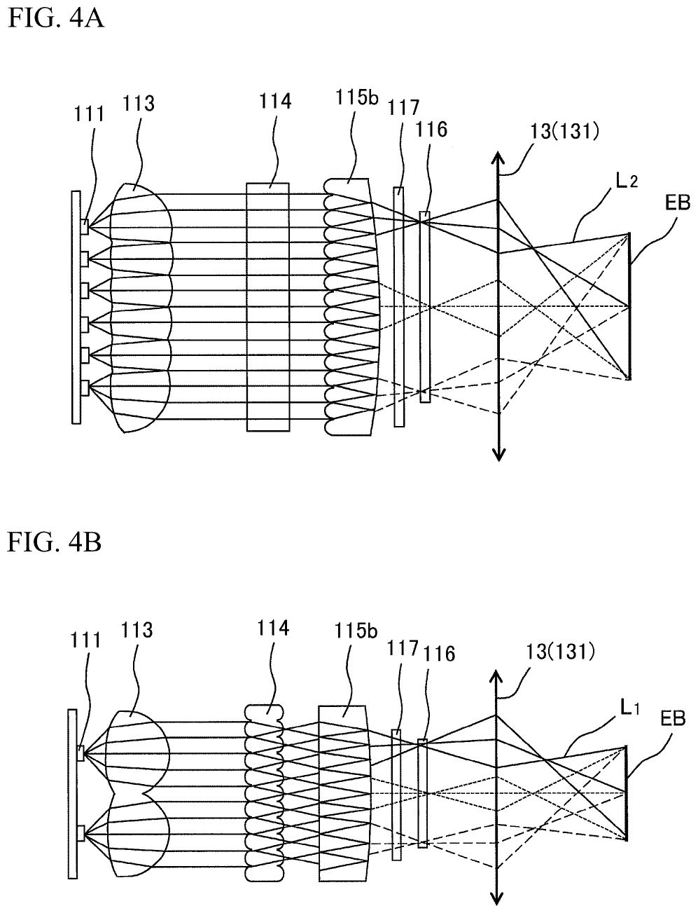

FIGS. 4A and 4B are diagrams depicting an example of a lens configuration and optical path (second optical path OP2) in the HUD device 1A of the present embodiment when the real image RI is displayed. FIG. 4A depicts a lens configuration and optical path as viewed in H-direction, and FIG. 4B depicts a lens configuration and optical path as viewed in V-direction. In FIGS. 4A and 4B, the condenser lens 113 and the first lenticular lens 114 have the same structures as those in FIGS. 3A and 3B. Thus, the condenser lens 113 turns the light emitted from the LEDs 111 into parallel light in both the H and V-directions, and the first lenticular lens 114 condenses the light of the LEDs 111 in relation to the V-direction to form a multiple image.

The second lenticular lens 115 also condenses the light of the LEDs 111 in relation to the H-direction to form a multiple image, in the same manner as described in FIG. 3A. Thus, analogous to FIG. 3A, the light receiving surface of the second lenticular lens 115, on a side facing the LEDs 111, is structured in such a manner that a plurality of cylindrical lenses, each having a convex curved surface facing the LEDs 111 as viewed in an H-direction cross-section, are disposed side-by-side along the H-direction. On the other hand, the light emitting surface is structured as a toroidal surface having a convex shape in both the V and H-directions, in order to realize light distribution characteristics such that the light sources 14 (LEDs 111) for displaying the real image RI emit illumination light so as to converge on the display 12 for displaying the real image RI while the light sources 14 for displaying the virtual image VI emit illumination light so as to diverge on the display 12. The light emitting surface having the convex shape makes the light distribution characteristics narrower in both the H and V-directions. The second lenticular lens 115 for displaying the real image RI is referred to as a second lens 115b.

The first display light L1 emitted from the second lens 115b is diffused by the diffuser plate 117 (not depicted in FIG. 1) to reduce uneven brightness, etc., enters the display 12 (LCP 116), generates an image (first display light L1) in accordance with the control of the control board (controller 15), and is emitted to the first mirror 131 of the subsequent imaging optical system 13. As depicted in FIGS. 4A and 4B, when the real image RI is displayed, the optical axes in both the H and V-directions are made to intersect between the windshield WS and the viewpoint EB (eye box) of the occupant DR as a viewer, in order to generate the real image RI. The intersections of the optical axes may be arbitrarily set according to the position and magnification of the real image RI to be displayed. Due to the above lens configuration and optical path, the occupant DR is able to visually recognize the real image RI with appropriate luminance and uniformity.

FIG. 5 is a functional block diagram depicting a configuration of a picture generation unit (PGU) in the HUD device 1A according to the first embodiment of the present disclosure. Note that FIG. 5 illustrates only a minimum necessary configuration directly related to the present disclosure, and other known configurations are omitted. In FIG. 5, the PGU 10 includes the controller 15, the backlight 11 (light sources 14), and the display 12, also depicted in FIGS. 1 and 2. The controller 15 includes a display controller 151 that issues a command to the display 12 so as to generate light representing a graphic of an arbitrary shape, on the basis of, for example, information sent from various devices 30, such as a vehicle speed sensor, a navigation unit, RADAR (Radio Detecting and Ranging), LiDAR (Laser Imaging Detection and Ranging), etc.; and a display driver 152 that generates image by using the light emitted from the light sources 14 of the backlight 11 on the basis of, for example, a signal sent from a switch 20 for changing a driving mode of the vehicle C (manual driving, automatic driving), switches the polarization of the emission light between the first and second polarization condition different from each other, and thus performs switching control of polarization direction of the display 12 that generates the display light (first display light L1 and second display light L2) representing the display image.

The controller 15 also includes a light source driver 153 that controls supply power necessary for turning on and off the light sources 14 mounted on the light-source circuit board 140 (see FIG. 7A) included in the backlight 11. The light source driver 153 controls the ON/OFF timing of each LED 111 (see FIGS. 3A, 3B, 4A and 4B) mounted on the light-source circuit board 140 as the light sources 14 and the value of a current (current value) flowing each LED 111, and also controls the supply power for the light sources 14, so as to be able to improve power efficiency.

The display 12 includes a TFT-type display element 121 that forms the display light (first display light L1 and second display light L2) representing a graphic of an arbitrary shape based on a signal sent from the display controller 151, and a polarization control element 122 that switches the display light L emitted according to a signal sent from the display driver 152 between the first display light L1 of the first polarization and the second display light L2 of the second polarization. In the configuration of FIG. 5, for example, at the time of manual driving, the display driver 152 controls the polarization control element 122 so as to emit the first display light L1 of the first polarization. At this time, the display controller 151 controls the display element 121 so as to generate the first display light L1 that represents vehicle information, routing assistance information, a warning, etc. Further, for example, at the time of automatic driving, the display driver 152 performs the switching control of the polarization control element 122 so as to emit the second display light L2 of the second polarization. At this time, the display controller 151 controls the display element 121 so as to generate the second display light L2 that represents an assistant or agent supporting the driving by occupant DR, a character indicating the assistant or agent, etc.

Thus, in the HUD device 1A according to the first embodiment of the present disclosure, when the virtual image VI is required to be displayed, the display 12 capable of controlling polarization sets the polarization condition of the backlight 11 (light sources 14) to the first polarization condition (first polarization) to be reflected by the first mirror 131 of the imaging optical system 13, so that the first display light L1 is reflected by the third mirror 133 to enter the windshield WS, is reflected by the windshield WS, and forms the virtual image VI (see the first optical path OP1 in FIG. 1) which can be displayed on the outer side of the windshield WS (an imaging region virtually set in front of the vehicle C so as to be inclined with respect to a road surface). On the other hand, when the real image RI is required to be displayed, the display 12 capable of controlling polarization sets the polarization condition of the backlight 11 (light sources 14) to the second polarization condition (second polarization) to be transmitted through the first mirror 131 of the imaging optical system 13, so that the second display light L2 is reflected by the second mirror 132 to enter the third mirror 133, is reflected by the third mirror 133 to enter the windshield WS, is reflected by the windshield WS, and forms the real image RI (see the second optical path OP2 in FIG. 2) which can be displayed on the inner side of the windshield WS in front of the occupant DR (an imaging region virtually set so as to be vertical with respect to a road surface).

For example, in the imaging region of the virtual image VI angled less than 45 degrees with respect to the road surface, the display content appears to be developed on the road surface, and therefore, in a case where navigation or the like is performed, the display content appears to be superimposed on the road surface, which realizes advantage of intuitive information presentation. On the other hand, it is assumed that the imaging region of the real image RI, angled not less than 45 degrees with respect to the road surface, is used in a scene such as viewing entertainment contents during automatic driving or parking, and therefore displaying the real image RI upright with respect to the road surface realizes advantage of improved visibility.

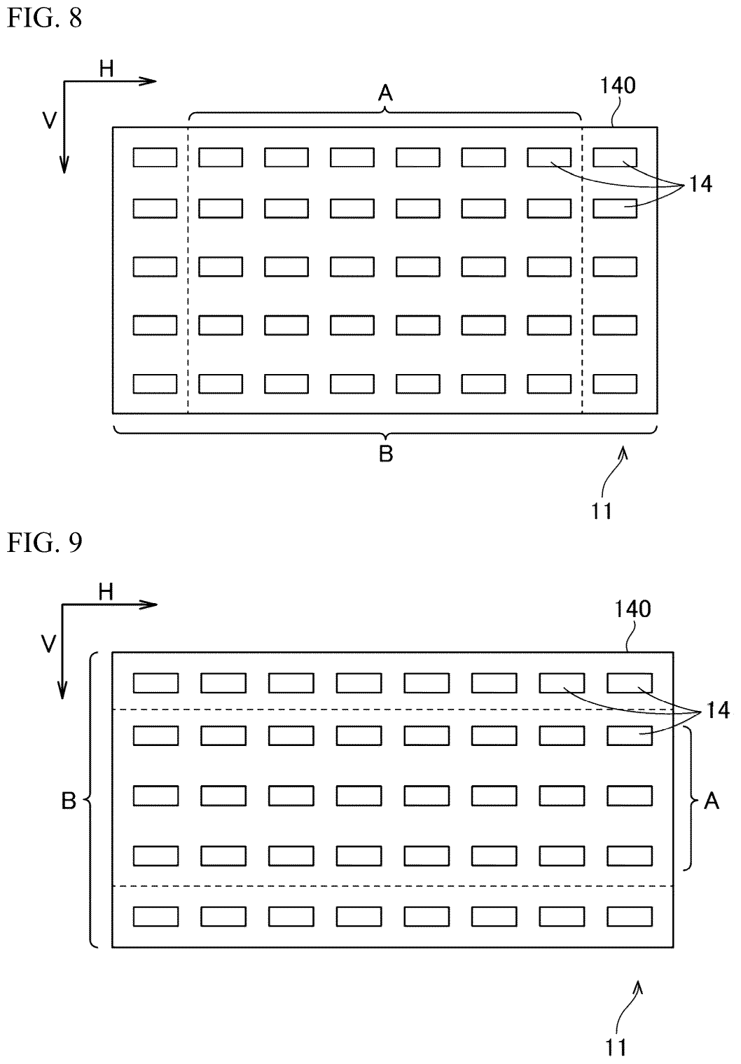

Further in the controller 15, the light source driver 153 controls the ON/OFF timing of each LED 111 (see FIGS. 3A, 3B, 4A and 4B) mounted on the light-source circuit board 140 as the light sources 14 and the value of a current (current value) flowing each LED 111, and also controls the supply power for the light sources 14, so as to be able to improve power efficiency. The light source driver 153 performs control such that an area of the light sources 14 to be turned-on more strongly than a predetermined intensity when the real image RI is to be displayed is made larger than an area of the light sources 14 turned-on more strongly than a predetermined intensity when the virtual image VI is displayed. In this connection, the “predetermined intensity” refers to an emission intensity of light, set in a default state, that is emitted from the backlight provided with the light sources mounted thereon to the display 12 when the virtual image VI or real image RI is to be displayed. In this embodiment, the level of the emission intensity is controlled based on the area of the light sources 14 to be turned on. Thus, when the real image RI is to be displayed, the control is performed in such a manner that the area of the light sources 14 to be turned-on more strongly than the predetermined intensity becomes larger than the area of the light sources 14 turned-on more strongly than the predetermined intensity for displaying the virtual image VI. In addition, the “area of the light sources to be turned-on” refers, for example, as depicted in FIG. 8 described later, to a mount area of the light sources to be turned-on (a turn-on area “A” upon generating virtual image, a turn-on area “B” upon generating real image) defined on the light-source circuit board 140 (backlight), among the plurality of light sources 14 mounted on the light-source circuit board 140.

### Operation of First Embodiment

Reference is made to FIG. 6. FIG. 6 is a flowchart depicting an example of the operation of a control system, specifically the controller 15, of the HUD device 1A according to the first embodiment of the present disclosure. FIG. 8 is a diagram depicting an example of a first light-source turning-on pattern of the light sources 14 mounted on the backlight 11, at the time of displaying the virtual image VI and the real image RI in the operation of FIG. 6. Hereinafter, the operation of the control system (PGU 10, mainly the controller 15) of the HUD device 1A depicted in FIG. 5 will be described in detail with reference to FIGS. 6 and 8.

In the PGU 10, the controller 15 (display driver 152) first determines whether the vehicle C is in manual driving or in automatic driving, based on a signal sent from the switch 20 for changing the driving mode (manual driving, automatic driving) of the vehicle C (step ST101). If it is determined that the vehicle C is in the manual driving (step ST101 “M”), the controller 15 (display controller 151) controls the display element 121 of the display 12 to generate the first display light L1 (virtual image VI) representing vehicle information, routing assistance information, a warning, and so forth (step ST102). At this time, the controller 15 (display driver 152) controls the imaging optical system 13 in such a manner that the first display light L1 of the first polarization is emitted via the polarization control element 122 of the display 12. Thus, the display driver 152 switches the imaging optical system 13 so as to project the first display light L1 from the emission port 17 toward the windshield WS through the first optical path OP1 (step ST103).

Subsequently, the controller 15 (light source driver 153) performs control to turn on at least a part of the LEDs 111 as the light sources 14 included in the backlight 11 (step ST104), and the display 12 emits (projects) the generated first display light L1 (virtual image VI) toward the windshield WS through the imaging optical system 13 (first optical path OP1) and the emission port 17 (step ST108).

On the other hand, if the vehicle C is in the automatic driving (step ST101 “A”), the controller 15 (display controller 151) controls the display element 121 to generate the second display light L2 representing an assistant or agent supporting the driving by occupant DR, a character indicating the assistant or agent, and so forth (step ST105). At this time, the controller 15 (the display driver 152) controls the imaging optical system 13 in such a manner that the second display light L2 of the second polarization is emitted via the polarization control element 122. Thus, the display driver 152 performs control to switch the optical path of the imaging optical system 13 from the first optical path OP1 to the second optical path OP2 so as to project the second display light L2 from the emission port 17 toward the windshield WS via the second optical path OP2 (step ST106).

Subsequently, the controller 15 (light source driver 153) performs control such that the area of the light sources 14 to be turned-on becomes larger than the area turned-on at the time of displaying the virtual image VI (step ST107). More specifically, as depicted in FIG. 8 for example, when the real image RI is to be displayed, the area of the light sources 14 mounted on the light-source circuit board 140 of the backlight 11 (turn-on area “B” upon generating real image), which are to be turned-on more strongly than a predetermined intensity, is made larger than the area of the light sources mounted on the light-source circuit board 140 (turn-on area “A” upon generating virtual image), which are turned-on more strongly than a predetermined intensity when the virtual image is displayed, along a long-side direction “H” of a rectangular region of the display 12. On the other hand, when the display image is switched from the real image RI to the virtual image VI, for example, the light sources 14 mounted on outer periphery in the long-side direction of the rectangular region of the display 12, used for displaying the real image VI, are controlled to be turned off.

Finally, the display 12 projects the generated second display light L2 (real image RI) toward the windshield WS as the projection member, via the imaging optical system 13 (second optical path OP2) and the emission port 17 (step ST108). As described above, the controller 15 performs the control such that, when the real image RI is to be displayed, the area of the light sources 14 to be turned-on more strongly than a predetermined intensity is made larger than the area of the light sources 14 turned-on more strongly than a predetermined intensity at the time of displaying the virtual image VI, and thereby makes it possible to suppress a disadvantage such that, when either one of the real image RI and the virtual image VI (e.g., real image) is displayed, light emitted from a pixel in a direction for displaying the other image (e.g., virtual image) is useless, and to improve light utilization efficiency. Therefore, it is possible to suppress a disadvantage such that, when either one of the real image RI and the virtual image VI is displayed, light emitted from a pixel in a direction for displaying the other image is useless, and thus to improve light utilization efficiency.

FIGS. 7A and 7B depict irradiation directions of light beams from each of a plurality of light sources 14 (LEDs 111 depicted in FIGS. 3A, 3B, 4A and 4B) mounted on the light-source circuit board 140 of the backlight 11 when viewing the light sources 14 from a normal direction, at the time of displaying the virtual image VI and the real image RI, respectively, in the HUD device 1A according to the first embodiment of the present disclosure. When the display image is changed so as to switch from the virtual image VI to the real image RI, the controller 15 performs control such that, as depicted in FIG. 7B for example, the light sources 14 (light beams indicated by solid arrows in the drawing) disposed at a mount region (i.e., outer peripheries Y1, Y2 of the light-source circuit board 140) not overlapping with the display 12 when viewing the light-source circuit board 140 of the backlight 11 from a normal direction, on which the light sources 14 are mounted, are turned-on more strongly than the predetermined intensity, and thereby makes it possible to suppress a disadvantage such that, when either one of the real image RI and the virtual image VI (e.g., real image RI) is displayed, light emitted from a pixel in a direction for displaying the other image (e.g., virtual image VI) is useless, and to improve light utilization efficiency. Note that, in FIGS. 7A and 7B, a solid arrow indicates a light beam used for display, and a broken arrow indicates a light beam not used for display.

FIGS. 8 to 11 depict four examples of light-source turning-on patterns (first to fourth light-source turning-on patterns) of the plurality of light sources 14 mounted on the backlight 11, at the time of displaying the virtual image V1 and the real image RI in the HUD device 1A according to the first embodiment of the present disclosure.

In the first light-source turning-on pattern depicted in FIG. 8, the controller 15 performs control such that, as depicted in FIG. 8 for example, the area of the light sources 14 mounted on the light-source circuit board 140 of the backlight 11 (turn-on area “B” upon generating real image), which are to be turned-on more strongly than a predetermined intensity when the real image is to be displayed, is made larger than the area of the light sources mounted on the light-source circuit board 140 (turn-on area “A” upon generating virtual image), which are turned-on more strongly than a predetermined intensity when the virtual image is displayed, along a long-side direction “H” of a rectangular region of the display 12. Alternatively, in the case of switching from a real image display to a virtual image display, control may be adopted such that, as depicted in FIG. 9 as the second light-source turning-on pattern for example, the light sources 14 on outer peripheries in a short-side direction “V” (upper and lower rows) of the turn-on area “B” upon generating real image are turned off.

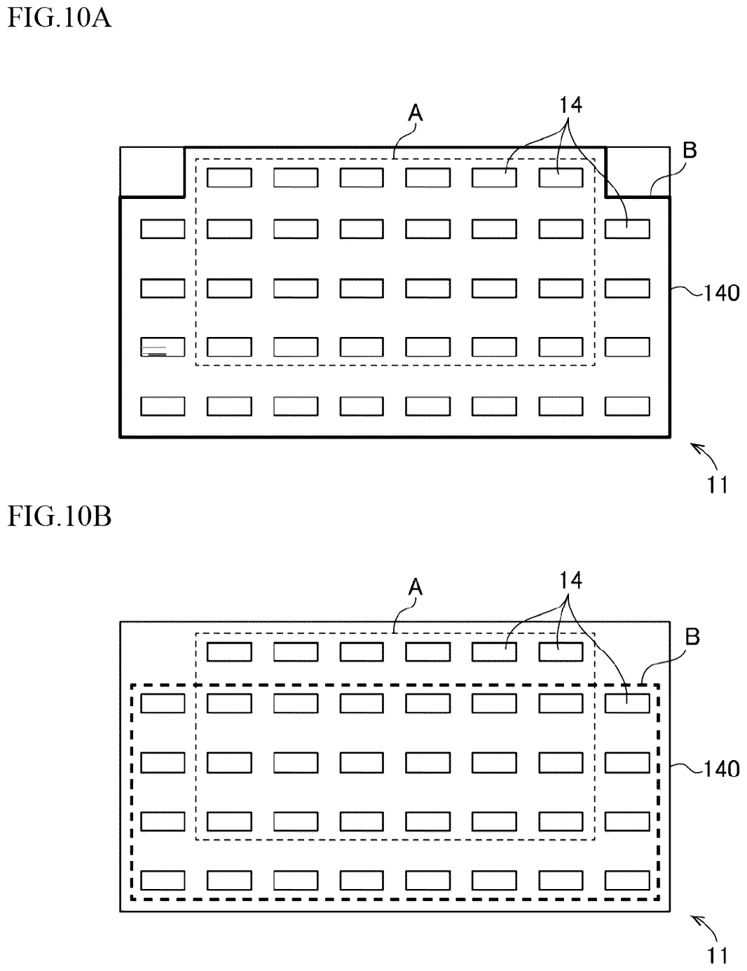

In the third light-source turning-on pattern depicted in FIGS. 10A and 10B, the controller 15 performs control such that the area of the light sources 14 mounted on the light-source circuit board 140 of the backlight 11 (turn-on area “B” upon generating real image), which are to be turned-on more strongly than a predetermined intensity when the real image RI is to be displayed, is made larger than the area of the light sources 14 mounted on the light-source circuit board 140 (turn-on area “A” upon generating virtual image), which are turned-on more strongly than a predetermined intensity when the virtual image VI is displayed, along each of the long-side direction “H” and short-side direction “V” of the rectangular region of the display 12. Therefore, it is possible to suppress a disadvantage such that, when either one of the real image and the virtual image is displayed, light emitted from a pixel in a direction for displaying the other image is useless, and to improve light utilization efficiency. Not limited to the turning-on patterns of the light sources 14 depicted in FIGS. 10A and 10B, other control may be adopted such that: (1) all light sources 14 arranged on outer peripheries of the light-source circuit board 140 are turned off; (2) the light sources 14 arranged at one periphery are turned off; (3) one periphery of each of the long “H” and short “V” sides is turned off; (4) a part of the light sources 14 is turned off when displaying the real image and then the part of the light sources 14 turned-off for displaying the real image is turned on when displaying the virtual image, and so forth.

In the third light-source turn-on pattern depicted in FIGS. 10A and 10B, the controller 15 performs the control such that, when the real image RI is to be displayed, the area of the light sources 14 mounted on the light-source circuit board 140 of the backlight 11 (turn-on area “B” upon generating real image), which are to be turned-on more strongly than a predetermined intensity, is made larger than the area of the light sources 14 mounted on the light-source circuit board 140 (turn-on area “A” upon generating virtual image), which are turned-on more strongly than a predetermined intensity when the virtual image VI is displayed, along each of the long-side direction “H” and short-side direction “V” of the rectangular region of the display 12. In this connection, as a modified light-source turn-on pattern, the controller 15 may perform control such that an increment of the area of the light sources 14 made larger along the long-side direction H is larger than an increment of the area of the light sources 14 made larger along the short-side direction V, and thereby make it possible to suppress a disadvantage such that, when either one of the real image RI and the virtual image VI is displayed, light emitted from a pixel in a direction for displaying the other image is useless, and to more effectively improve light utilization efficiency.

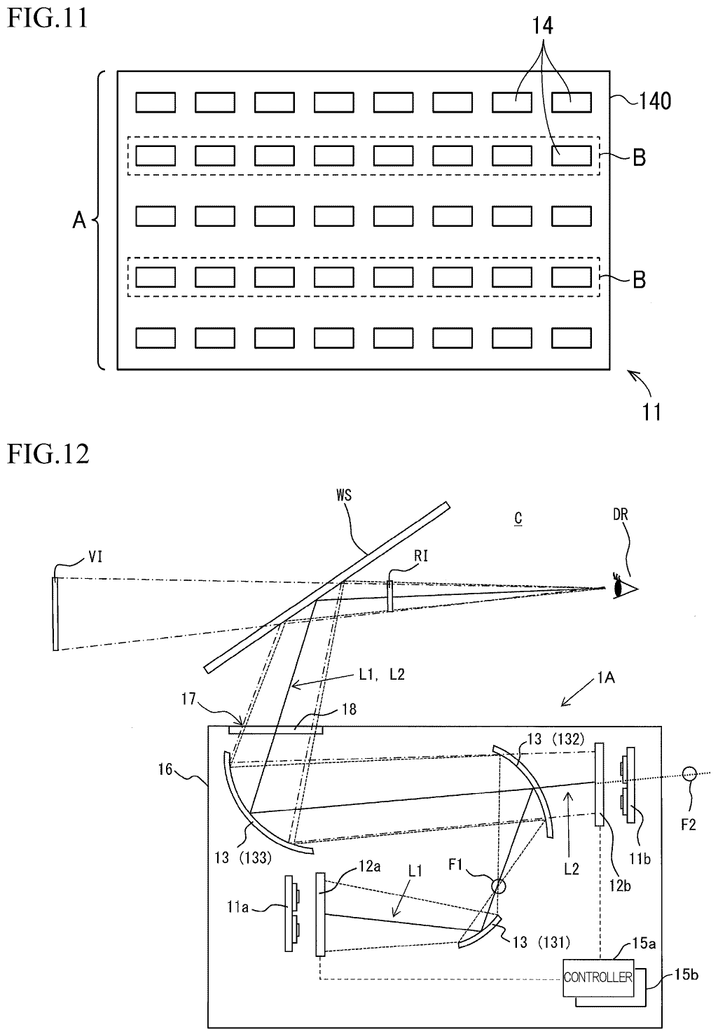

Also, as depicted in FIG. 11 as the fourth light-source turn-on pattern, the controller 15 may perform control such that all light sources of the backlight (turn-on area “A” upon generating virtual image) are tuned on when displaying the real image RI and a part of the light sources 14 (turn-on area “B” upon generating real image surrounded by a broken line) mounted on the inner side of the light-source circuit board 140 except for outer peripheries along the short-side direction are turned off when displaying the virtual image VI.

### Effects of First Embodiment

As described above, the head-up display device 1A according to the first embodiment is embodied as the head-up display device (HUD device 1A) that, as depicted in FIGS. 1 and 2 for example, is provided with the emission port 17 and emits the display light L from the emission port 17 toward the projection member (windshield WS) so as to allow the virtual and real images of the display image represented by the display light L to be visually recognized. The HUD device 1A includes the backlight 11 that includes a plurality of light sources 14 (FIGS. 7A and 7B) mounted thereon; the display 12 that transmits illumination light emitted from the light sources 14 and generates the display light L; the polarization control element 122 that switches between polarization conditions of the display light L; the imaging optical system 13 that causes the first display light L1 of a first polarization condition to be emitted from the emission port 17 via the first optical path OP1 having a first optical path-length to form the virtual image VI, and causes the second display light L2 of a second polarization condition to be emitted from the emission port 17 via the second optical path OP2 having a second optical path-length longer than the first optical path-length to form the real image RI; and the controller 15 that controls the polarization conditions of the display light L switched by the polarization control element 122 and turning on and off of each of the light sources 14. The controller 15 performs the control such that, when the real image RI is to be displayed, the area of the light sources 14 to be turned-on more strongly than a predetermined intensity is made larger than the area of the light sources 14 turned-on more strongly than a predetermined intensity when the virtual image VI is displayed.

In the HUD device 1A according to the first embodiment of the present disclosure, the controller 15 performs the control such that, when the real image RI is to be displayed, the area of the light sources 14 to be turned-on more strongly than a predetermined intensity is made larger than the area of the light sources 14 turned-on more strongly than a predetermined intensity when the virtual image VI is displayed. For example, performing control such that, when the real image is displayed, the outer periphery of the light source region is turned on, whereas when the virtual image is displayed, the outer periphery of the light source region, which is not visually recognized as the virtual image, is turned off, makes it possible to eliminate a difference in brightness between the time of displaying the real image RI and the time of displaying the virtual image VI while suppressing the generation of useless light, and thus to improve light utilization efficiency. In this way, it is possible to suppress a disadvantage such that, when either one of the real image and the virtual image is displayed, light emitted from a pixel in a direction for displaying the other image is useless, and thus to improve the light utilization efficiency.

Also in the HUD device 1A according to the first embodiment of the present disclosure, when the display image is changed so as to switch from the virtual image VI to the real image RI, the controller 15 performs control such that, as depicted in FIG. 7B for example, the light sources 14 (light beams indicated by solid arrows in the drawing) disposed at a mount region (i.e., outer peripheries Y1, Y2 of the light-source circuit board 140) not overlapping with the display 12 when viewing the light-source circuit board 140 of the backlight 11 from a normal direction, on which the light sources 14 are mounted, are turned-on more strongly than the predetermined intensity, and thereby makes it possible to suppress a disadvantage such that, when either one of the real image RI and the virtual image VI (e.g., real image RI) is displayed, light emitted from a pixel in a direction for displaying the other image (e.g., virtual image VI) is useless, and to improve light utilization efficiency.

Also in the HUD device 1A according to the first embodiment of the present disclosure, the controller 15 performs control such that, as depicted in FIG. 8 for example, the area of the light sources 14 mounted on the light-source circuit board 140 of the backlight 11 (turn-on area “B” upon generating real image), which are to be turned-on more strongly than the predetermined intensity when the real image RI is to be displayed, is made larger than the area of the light sources 14 mounted on the light-source circuit board 140 (turn-on area “A” upon generating virtual image), which are turned-on more strongly than the predetermined intensity when the virtual image VI is displayed, along a long-side direction “H” of a rectangular region of the display 12. Alternatively, when changing a display from the real image RI to the virtual image VI, control may be adopted such that, as depicted in FIG. 9 for example, the light sources 14 on outer peripheries in a short-side direction “V” (upper and lower rows) of the turn-on area “B” upon generating real image are turned off. Due to the above, it is possible to suppress a disadvantage such that, when either one of the real image RI and the virtual image VI is displayed, light emitted from a pixel in a direction for displaying the other image is useless, and thus to improve the light utilization efficiency.

Also in the HUD device 1A according to the first embodiment of the present disclosure, the controller 15 performs control such that, as depicted in FIGS. 10A and 10B for example, the area of the light sources 14 mounted on the light-source circuit board 140 of the backlight 11 (turn-on area “B” upon generating real image), which are to be turned-on more strongly than the predetermined intensity when the real image RI is to be displayed, is made larger than the area of the light sources 14 mounted on the light-source circuit board 140 (turn-on area “A” upon generating virtual image), which are turned-on more strongly than the predetermined intensity when the virtual image VI is displayed, along each of the long-side direction “H” and short-side direction “V” of the rectangular region of the display 12. Therefore, it is possible to suppress a disadvantage such that, when either one of the real image and the virtual image is displayed, light emitted from a pixel in a direction for displaying the other image is useless, and to improve light utilization efficiency. Not limited to the turning-on patterns of the light sources 14 depicted in FIGS. 10A and 10B, other control may be adopted such that: (1) all light sources 14 arranged on outer peripheries of the light-source circuit board 140 are turned off; (2) the light sources 14 arranged at one periphery are turned off; (3) one periphery of each of the long “H” and short “V” sides is turned off; (4) a part of the light sources 14 is turned off when displaying the real image RI and then the part of the light sources 14 turned-off for displaying the real image RI is turned on when displaying the virtual image VI, and so forth.

Also in the HUD device 1A according to the first embodiment of the present disclosure, the controller 15 performs the control such that, as depicted in FIGS. 10A and 10B for example, when the real image RI is to be displayed, the area of the light sources 14 mounted on the light-source circuit board 140 of the backlight 11 (turn-on area “B” upon generating real image), which are to be turned-on more strongly than the predetermined intensity, is made larger than the area of the light sources 14 mounted on the light-source circuit board 140 (turn-on area “A” upon generating virtual image), which are turned-on more strongly than the predetermined intensity when the virtual image VI is displayed, along each of the long-side direction “H” and short-side direction “V” of the rectangular light-source circuit board 140 of the display 12, and that an increment of the area of the light sources 14 made larger along the long-side direction H is larger than an increment of the area of the light sources 14 made larger along the short-side direction V, and thereby makes it possible to suppress a disadvantage such that, when either one of the real image RI and the virtual image VI is displayed, light emitted from a pixel in a direction for displaying the other image is useless, and to more effectively improve light utilization efficiency.

A method of controlling a head-up display device according to the first embodiment of the present disclosure is embodied as a method of controlling the HUD device 1A including, as depicted in FIGS. 1 and 2 for example, a backlight 11 that includes a light-source circuit board 140 provided with a plurality of light sources 14 mounted thereon; a display 12 that transmits illumination light from the light sources 14 of the backlight 11 and generates display light L; a polarization control element 122 that switches between polarization conditions of the display light L; an imaging optical system 13 that causes first display light L1 of a first polarization condition to be emitted from an emission port 17 via a first optical path OP1 having a first optical path-length to form a virtual image VI, and causes second display light L2 of a second polarization condition to be emitted from the emission port 17 via a second optical path OP2 having a second optical path-length longer than the first optical path-length to form a real image RI; and a controller 15 that controls the polarization conditions of the display light L switched by the polarization control element 122 and turning on and off of each of the light sources 14 of the backlight 11. The control method includes a step (see ST106) of switching, by the controller 15 of the HUD device 1A, the imaging optical system 13 from the first optical path OP1 to the second optical path OP2 to change the display image from the virtual image VI to the real image RI; and a step (see ST107) of performing, by the controller 15, control such that an area of the light sources 14 mounted on the light-source circuit board 140, which are to be turned-on more strongly than a predetermined intensity when the real image RI is to be displayed, is made larger than an area of the light sources 14 turned-on more strongly than a predetermined intensity when the virtual image VI is displayed.

In the control method of the HUD device 10A according to the first embodiment of the present disclosure, the controller 15 executes the procedure (step ST107) of performing the control such that, when the real image RI is to be displayed, the area of the light sources 14 to be turned-on more strongly than the predetermined intensity is made larger than the area of the light sources 14 turned-on more strongly than the predetermined intensity when displaying the virtual image VI, and such that, for example, the outer periphery of the light source region is turned on when displaying the real image RI, and on the other hand, the outer periphery of the light source region, which is not visually recognized as the virtual image VI, is turned off when displaying the virtual image VI, so that it is possible to eliminate a difference in brightness between the time of displaying the real image and the time of displaying the virtual image while suppressing the generation of useless light, and thus to improve light utilization efficiency. Thus, it is possible to suppress a disadvantage such that, when either one of the real image RI and the virtual image VI is displayed, light emitted from a pixel in a direction for displaying the other image is useless, and thus to improve the light utilization efficiency.

### Configuration of Second Embodiment

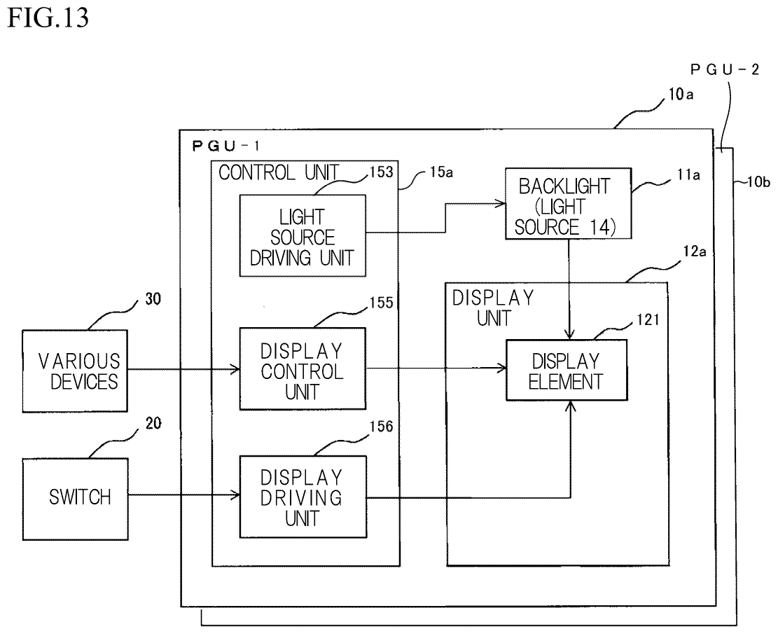

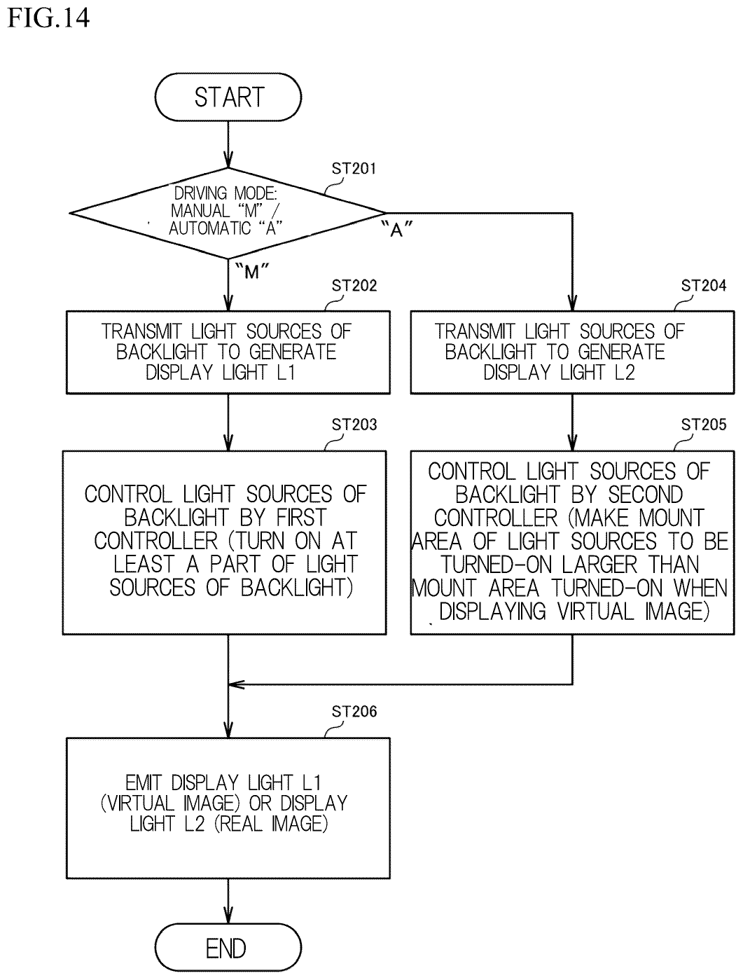

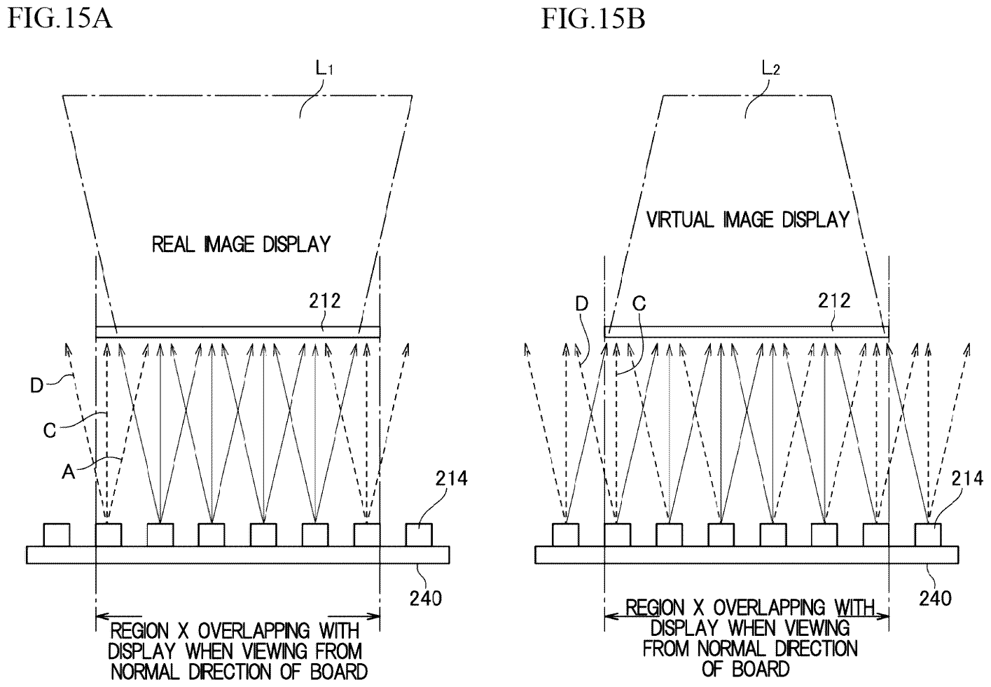

FIG. 12 is a diagram depicting an example of a configuration of a HUD device 1B according to a second embodiment of the present disclosure, which includes an imaging optical system. FIG. 13 is a diagram depicting an example of a configuration of a control system of the HUD device 1B according to the second embodiment of the present disclosure, and FIG. 14 is a flowchart depicting an example of an operation of the control system of the HUD device 1B according to the second embodiment of the present disclosure. Hereinafter, the configuration and operation of the HUD device 1B according to the second embodiment of the present disclosure will be described in detail with reference to FIGS. 12 to 14.

Reference is made to FIG. 12. The HUD device 1B according to the second embodiment depicted in FIG. 12 is different from the HUD device 1A of the first embodiment depicted in FIGS. 1 and 2 in a configuration such that the HUD device 1B of the second embodiment is provided with dual systems, each including the backlight 11, the display 12 and the controller 15 included in the HUD device 1A of the first embodiment, and thus, lenses of the imaging optical system 13 are optimally designed according to orientation characteristics required for displaying each of the real image RI and virtual image VI, and are independently controlled for displaying the real image RI and virtual image VI by dual-system controllers 15.

The HUD device 1B according to the second embodiment includes, as depicted in FIG. 12 for example, a first backlight 11a that includes a plurality of first light sources mounted thereon; a first display 12a that transmits illumination light from the first light sources and generates first display light L1; a second backlight 11b that includes a plurality of second light sources mounted thereon; a second display 12b that transmits illumination light from the second light sources and generates second display light L2; an imaging optical system 13 that causes the first display light L1 of a first polarization condition to be emitted from an emission port 17 via a first optical path having a first optical path-length to form the virtual image VI, and causes the second display light L2 of a second polarization condition to be emitted from the emission port 17 via a second optical path having a second optical path-length longer than the first optical path-length to form the real image RI; a first controller 15a that controls turning on and off of each of the first light sources; and a second controller 15b that controls turning on and off of each of the second light sources.

As depicted in FIG. 13 for example, the controllers 15a and 15b are included in dual-system picture generation units PGU-1 (PGU 10a) and PGU-2 (PGU 10b), respectively. The first controller 15a performs control such that the first light sources are turned-on more strongly than a predetermined intensity when the virtual image VI is to be displayed by the first display light L1, and the second controller 15b performs control such that an area of the light sources to be turned-on more strongly than a predetermined intensity when the real image RI is to be displayed by the second display light L2 is made larger than an area of the light sources to be turned-on more strongly than the predetermined intensity when the virtual image VI is displayed.

As depicted in FIG. 13 as a functional block diagram, the PGU-1 (PGU 10a) includes the backlight 11a (light sources 14), the display 12a, and the controller 15a. The controller 15a includes a display controller 155 that issues a command to the display 12a so as to generate the first display light L1 (virtual image VI) representing a display image on the basis of, for example, information or signals sent from various devices 30, such as a vehicle speed sensor, a navigation unit, RADAR, LiDAR, etc.; a display driver 156 that generates image by using the light emitted from the light sources 14 of the backlight 11 and drives a display element 121 on the basis of, for example, a signal sent from a switch 20 for changing a driving mode of the vehicle C (manual driving, automatic driving); and a light source driver 153 that controls supply power necessary for turning on and off the light sources 14 mounted on a light-source circuit board 140 (see FIGS. 7A and 7B) included in the backlight 11. The light source driver 153 controls the ON/OFF timing of each LED 111 mounted on the light-source circuit board 140 as the light sources 14 and the value of a current (current value) flowing each LED 111, and also controls the supply power for the light sources 14, so as to be able to improve power efficiency.

The display 12a includes a thin film transistor (TFT) type display element 121 that forms the first display light L1 representing a graphic of an arbitrary shape based on a signal sent from the controller 15a (display controller 155). For example, at the time of manual driving, the display driver 156 performs switching control, and at this time, the display controller 155 controls the display element 121 of the display 12a so as to generate the first display light L1 (virtual image VI) representing vehicle information, routing assistance information, a warning, etc.

Although not depicted, the PGU-2 (PGU 10b) has a configuration analogous to that of the PGU-1 (PGU 10a) except for the controller 15b, and includes the backlight 11b (light sources 14B), the display 12b and the controller 15b (all not depicted). The controller 15b includes a light source driver 153, a display controller 155, and a display driver 156. The display 12b includes a TFT-type display element 121 that forms the second display light L2 representing a graphic of an arbitrary shape based on a signal sent from the controller 15b (display controller 155). For example, at the time of automatic driving, the display driver 156 performs switching control, and at this time, the display controller 155 controls the display element 121 so as to generate the second display light L2 (real image RI) that represents an assistant or agent supporting the driving by occupant DR, a character indicating the assistant or agent, etc.

The controller 15a (light source driver 153) of the PGU-1 (PGU 10a) performs the control such that the light sources of the backlight 11 are turned-on more strongly than a predetermined intensity when the virtual image VI is to be displayed by the first display light L1, whereas the controller 15b (light source driver 153) of the PGU-2 (PGU 10b) performs the control such that an area of the light sources 14B of the backlight 11 to be turned-on more strongly than a predetermined intensity when the real image RI is to be displayed by the second display light L2 is made larger than an area of the light sources to be turned-on more strongly than the predetermined intensity when the virtual image VI is displayed.

### Operation of Second Embodiment

Specifically, as depicted in FIG. 14 as a flowchart, the controller 15a (display driver 152) determines whether the vehicle C is in manual driving or in automatic driving, based on a signal sent from the switch 20 for changing the driving mode (manual driving, automatic driving) of the vehicle C (step ST201). If it is determined that the vehicle C is in the manual driving (step ST201 “M”), the controller 15a (display controller 155) controls the display element 121 of the display 12a to generate the first display light L1 (virtual image VI) representing vehicle information, routing assistance information, a warning, and so forth (step ST202). Subsequently, the controller 15a (light source driver 153) performs control to turn on at least a part of the LEDs 111 (e.g., front light) as the light sources 14 of the backlight 11 (step ST203), and the display 12a emits the generated first display light L1 (virtual image VI) from the emission port 17 via the first optical path having the first optical path-length (imaging optical system 13) and projects the light toward the windshield WS (step ST206).

On the other hand, if the vehicle C is in the automatic driving (step ST201 “A”), the controller 15b (display controller 155) controls the display element 121 of the display 12b to generate the second display light L2 (real image RI) representing an assistant or agent supporting the driving by occupant DR, a character indicating the assistant or agent, and so forth (step ST204). Subsequently, the controller 15b (the light source driver 153) performs control such that the area of the light sources 14 to be turned-on becomes larger than the area turned-on at the time of displaying the virtual image VI (step ST205). More specifically, as depicted in FIG. 8 for example, when the real image RI is to be displayed, the area of the light sources 14 mounted on the light-source circuit board 140 of the backlight 11b (turn-on area “B” upon generating real image), which are to be turned-on more strongly than a predetermined intensity, is made larger than the area of the light sources mounted on the light-source circuit board 140 (turn-on area “A” upon generating virtual image), which are turned-on more strongly than a predetermined intensity when the virtual image VI is displayed, along a long-side direction “H” of the rectangular light-source circuit board 140 of the display 12b. On the other hand, when the display image is switched from the real image RI to the virtual image VI, for example, the light sources 14 mounted on outer periphery in the long-side direction of the display 12b, used for displaying the real image VI, are controlled to be turned off.

Finally, the display 12b projects the generated display light L2 (real image V1) toward the windshield WS via the second optical path (imaging optical system 13) having the second optical path-length longer than the first optical path-length and the emission port 17 (step ST206).

As described above, the HUD device 1B that includes dual systems for generating the virtual images VI and the real images RI, each including the light sources 14 of the backlight 11, the display 12 and the controller 15, and shares the imaging optical system 13, has a configuration in which the first controller 15a performs the control such that the first light sources of the backlight 11a are turned-on more strongly than a predetermined intensity when the virtual image VI is to be displayed by the first display light L1, and the second controller 15b performs the control such that an area of the second light sources to be turned-on more strongly than a predetermined intensity when the real image RI is to be displayed by the second display light L2 is made larger than an area of the first light sources to be turned-on more strongly than the predetermined intensity when the virtual image VI is displayed. For example, performing control such that, when the real image RI is displayed, the outer periphery of the light source region is turned on, whereas when the virtual image VI is displayed, the outer periphery of the light source region, which is not visually recognized as the virtual image VI, is turned off, makes it possible to eliminate a difference in brightness between the time of displaying the real image RI and the time of displaying the virtual image VI while suppressing the generation of useless light, and thus to improve light utilization efficiency. In this way, it is possible to suppress a disadvantage such that, when either one of the real image and the virtual image is displayed, light emitted from a pixel in a direction for displaying the other image is useless, and thus to improve the light utilization efficiency.

### Effects of Second Embodiment

As described above, the head-up display device according to the second embodiment of the present disclosure is embodied as the HUD device 1B that, as depicted in FIG. 12 for example, is provided with the emission port 17 and emits the display light L from the emission port 17 toward the projection member (windshield WS) so as to allow the virtual image VI and real image RI of the display image represented by the display light L to be visually recognized. The HUD device 1B includes the first backlight 11a that includes a plurality of first light sources mounted thereon; the first display 12a that transmits illumination light from the first light sources and generates the first display light L1; the second backlight 11b that includes a plurality of second light sources mounted thereon; the second display 12b that transmits illumination light from the second light sources and generates the second display light L2; the imaging optical system 13 that causes the first display light L1 to be emitted from the emission port 17 via the first optical path having the first optical path-length to form the virtual image VI, and causes the second display light L2 to be emitted from the emission port 17 via the second optical path having the second optical path-length longer than the first optical path-length to form the real image RI; the first controller 15a that controls turning on and off of each of the first light sources; and the second controller 15b that controls turning on and off of each of the second light sources. The first controller 15a performs the control such that, when the virtual image VI is to be displayed by the first display light L1, the first light sources are turned-on more strongly than a predetermined intensity, and the second controller 15b performs the control such that, when the real image RI is to be displayed by the second display light L2, an area of the light sources to be turned-on more strongly than a predetermined intensity is made larger than an area of the light sources to be turned-on more strongly than the predetermined intensity when the virtual image VI is displayed.

In the HUD device 1B according to the second embodiment of the present disclosure, which is provided with dual systems for generating the virtual images VI and the real images RI, each including the light sources 14 of the backlight 11, the display 12 and the controller 15, and shares the imaging optical system 13, the HUD device 1B has a configuration for executing procedures (steps) in which the first controller 15a performs the control such that the first light sources are turned-on more strongly than a predetermined intensity when the virtual image VI is to be displayed by the first display light L1, and the second controller 15b performs the control such that an area of the light sources to be turned-on more strongly than a predetermined intensity when the real image RI is to be displayed by the second display light L2 is made larger than an area of the light sources to be turned-on more strongly than the predetermined intensity when the virtual image VI is displayed. According to the above configuration, performing control such that, for example, the outer periphery of the light source region is turned on when the real image RI is displayed, whereas the outer periphery of the light source region, which is not visually recognized as the virtual image VI, is turned off when the virtual image VI is displayed, makes it possible to eliminate a difference in brightness between the time of displaying the real image RI and the time of displaying the virtual image VI while suppressing the generation of useless light, and thus to improve light utilization efficiency. Thus, it is possible to suppress a disadvantage such that, when either one of the real image RI and the virtual image VI is displayed, light emitted from a pixel in a direction for displaying the other image is useless, and thus to improve the light utilization efficiency.

A method of controlling a head-up display device according to the second embodiment of the present disclosure is embodied as a method of controlling the HUD device 1B including, as depicted in FIG. 12 for example, the emission port 17 and emitting the display light L from the emission port 17 toward the projection member (windshield WS) so as to allow the virtual image VI and real image RI of the display image represented by the display light L to be visually recognized, in which the HUD device 1B includes the first backlight 11a that includes a plurality of first light sources mounted thereon; the first display 12a that transmits illumination light from the first light sources and generates the first display light L1; the second backlight 11b that includes a plurality of second light sources mounted thereon; the second display 12b that transmits illumination light from the second light sources and generates the second display light L2; the imaging optical system 13 that causes the first display light L1 to be emitted from the emission port 17 via the first optical path having the first optical path-length to form the virtual image VI, and causes the second display light L2 to be emitted from the emission port 17 via the second optical path having the second optical path-length longer than the first optical path-length to form the real image RI; the first controller 15a that controls turning on and off of each of the first light sources; and the second controller 15b that controls turning on and off of each of the second light sources. The control method includes a step of performing, by the first controller 15a, the control such that, when the virtual image VI is to be displayed by the first display light L1, the first light sources are turned-on more strongly than a predetermined intensity, and a step of performing, by the second controller 15b, the control such that, when the real image RI is to be displayed by the second display light L2, an area of the light sources to be turned-on more strongly than a predetermined intensity is made larger than an area of the light sources to be turned-on more strongly than the predetermined intensity when the virtual image VI is displayed.

In the control method of the HUD device 1B according to the second embodiment of the present disclosure, which is provided with dual systems for generating the virtual images VI and the real images RI, each including the light sources 14 of the backlight 11, the display 12 and the controller 15, and shares the imaging optical system 13, the method has a configuration for executing procedures (steps) in which the first controller 15a performs the control such that the first light sources are turned-on more strongly than a predetermined intensity when the virtual image VI is to be displayed by the first display light L1, and the second controller 15b performs the control such that an area of the light sources to be turned-on more strongly than a predetermined intensity when the real image RI is to be displayed by the second display light L2 is made larger than an area of the light sources to be turned-on more strongly than the predetermined intensity when the virtual image VI is displayed. According to the above procedure, performing control such that, for example, the outer periphery of the light source region is turned on when the real image RI is displayed, whereas the outer periphery of the light source region, which is not visually recognized as the virtual image VI, is turned off when the virtual image VI is displayed, makes it possible to eliminate a difference in brightness between the time of displaying the real image RI and the time of displaying the virtual image VI while suppressing the generation of useless light, and thus to improve light utilization efficiency. In this way, it is possible to suppress a disadvantage such that, when either one of the real image and the virtual image is displayed, light emitted from a pixel in a direction for displaying the other image is useless, and thus to improve the light utilization efficiency.

In the above embodiments of the present disclosure, the windshield WS is used as a light-transmissive member. However, a flat glass or a combiner may be used instead.

The present disclosure is not limited to the exemplary embodiments described above, and a person skilled in the art can readily modify the above exemplary embodiments within the scope of the following claims.

### REFERENCE SIGNS LIST

1 (1A, 1B) . . . HEAD-UP DISPLAY DEVICE (HUD DEVICE)
10 . . . PICTURE GENERATION UNIT (PGU)
10a . . . FIRST PICTURE GENERATION UNIT (PGU-1)
10b . . . SECOND PICTURE GENERATION UNIT (PGU-2)
11 . . . BACKLIGHT
11a . . . FIRST BACKLIGHT
11b . . . SECOND BACKLIGHT
12 . . . DISPLAY
12a . . . FIRST DISPLAY
12b . . . SECOND DISPLAY
13 IMAGING OPTICAL SYSTEM
14 . . . LIGHT SOURCE
15 . . . CONTROLLER
15a . . . FIRST CONTROLLER
15b . . . SECOND CONTROLLER
17 . . . EMISSION PORT
20 . . . SWITCH
30 . . . VARIOUS DEVICES
131 . . . FIRST MIRROR
132 . . . SECOND MIRROR
133 . . . THIRD MIRROR
121 . . . DISPLAY ELEMENT
122 . . . POLARIZATION CONTROL ELEMENT
151 . . . DISPLAY CONTROLLER
152 . . . DISPLAY DRIVER
153 . . . LIGHT-SOURCE DRIVER
140 . . . LIGHT-SOURCE CIRCUIT BOARD
RI . . . REAL IMAGE
VI . . . VIRTUAL IMAGE
L1 . . . FIRST DISPLAY LIGHT
L2 . . . SECOND DISPLAY LIGHT
OP1 . . . FIRST OPTICAL PATH
OP2 . . . SECOND OPTICAL PATH

1. A head-up display device provided with an emission port and emitting display light from the emission port toward a projection member so as to allow virtual and real images of a display image represented by the display light to be visually recognized, the head-up display device comprising:
a backlight that includes a plurality of light sources mounted thereon;
a display that transmits illumination light emitted from the light sources and generates the display light;
a polarization control element that switches between polarization conditions of the display light;
an imaging optical system that causes first display light of a first polarization condition to be emitted from the emission port via a first optical path having a first optical path-length to form the virtual image, and causes second display light of a second polarization condition to be emitted from the emission port via a second optical path having a second optical path-length longer than the first optical path-length to form the real image; and
a controller that controls the polarization conditions of the display light switched by the polarization control element and turning on and off of each of the light sources,
wherein the controller performs control such that an area of the light sources to be turned-on more strongly than a predetermined intensity when the real image is to be displayed is larger than an area of the light sources to be turned-on more strongly than a predetermined intensity when the virtual image is displayed.

2. The head-up display device of claim 1,
wherein the controller further performs control such that, when the display image is changed so as to switch from the virtual image to the real image, a light source disposed at a mount region not overlapping with the display when viewing a light-source circuit board of the backlight from a normal direction, on which the light sources are mounted, is turned-on more strongly than the predetermined intensity.

3. The head-up display device of claim 1,
wherein the controller performs control such that the area of the light sources mounted on a light-source circuit board of the backlight, which are to be turned-on more strongly than the predetermined intensity when the real image is to be displayed, is larger than the area of the light sources mounted on the light-source circuit board, which are turned-on more strongly than the predetermined intensity when the virtual image is displayed, along a long-side direction of a rectangular region of the display.

4. The head-up display device of claim 1,
wherein the controller performs control such that the area of the light sources mounted on a light-source circuit board of the backlight, which are to be turned-on more strongly than the predetermined intensity when the real image is to be displayed, is larger than the area of the light sources mounted on the light-source circuit board, which are turned-on more strongly than the predetermined intensity when the virtual image is displayed, along each of long-side and short-side directions of a rectangular region of the display.

5. The head-up display device of claim 1,
wherein the controller performs control such that the area of the light sources mounted on a light-source circuit board of the backlight, which are to be turned-on more strongly than the predetermined intensity when the real image is to be displayed, is larger than the area of the light sources mounted on the light-source circuit board, which are turned-on more strongly than the predetermined intensity when the virtual image is displayed, along each of long-side and short-side directions of a rectangular region of the display, and that an increment of the area of the light sources made larger along the long-side direction is larger than an increment of the area of the light sources made larger along the short-side direction.

6. A head-up display device provided with an emission port and emitting display light from the emission port toward a projection member so as to allow virtual and real images of a display image represented by the display light to be visually recognized, the head-up display device comprising:
a first backlight that includes a plurality of first light sources mounted thereon;
a first display that transmits illumination light from the first light sources and generates first display light;
a second backlight that includes a plurality of second light sources mounted thereon;
a second display that transmits illumination light from the second light sources and generates second display light;
an imaging optical system that causes the first display light to be emitted from the emission port via a first optical path having a first optical path-length to form the virtual image, and causes the second display light to be emitted from the emission port via a second optical path having a second optical path-length longer than the first optical path-length to form the real image;
a first controller that controls turning on and off of each of the first light sources; and
a second controller that controls turning on and off of each of the second light sources,
wherein the first controller performs control such that the first light sources are turned-on more strongly than a predetermined intensity when the virtual image is to be displayed by the first display light, and
wherein the second controller performs control such that an area of the light sources to be turned-on more strongly than a predetermined intensity when the real image is to be displayed by the second display light is larger than an area of the light sources to be turned-on more strongly than the predetermined intensity when the virtual image is displayed.

7. A method of controlling a head-up display device including a backlight that includes a light-source circuit board provided with a plurality of light sources mounted thereon; a display that transmits illumination light from the light sources of the backlight and generates display light; a polarization control element that switches between polarization conditions of the display light; an imaging optical system that causes first display light of a first polarization condition to be emitted from an emission port via a first optical path having a first optical path-length to form a virtual image, and causes second display light of a second polarization condition to be emitted from the emission port via a second optical path having a second optical path-length longer than the first optical path-length to form a real image; and a controller that controls the polarization conditions of the display light switched by the polarization control element and turning on and off of each of the light sources of the backlight, the method comprising:
switching, by the controller, the imaging optical system from the first optical path to the second optical path to change a display image from the virtual image to the real image; and
performing, by the controller, control such that an area of a light source region of the light sources mounted on the light-source circuit board, which are to be turned-on more strongly than a predetermined intensity when the real image is to be displayed, is larger than an area of a light source region of the light sources to be turned-on more strongly than a predetermined intensity when the virtual image is displayed.

8. A method of controlling a head-up display device provided with an emission port and emitting display light from the emission port toward a projection member so as to allow virtual and real images of a display image represented by the display light to be visually recognized, the head-up display device including a first backlight that includes a plurality of first light sources mounted thereon; a first display that transmits illumination light from the first light sources and generates first display light; a second backlight that includes a plurality of second light sources mounted thereon; a second display that transmits illumination light from the second light sources and generates second display light; an imaging optical system that causes the first display light to be emitted from the emission port via a first optical path having a first optical path-length to form the virtual image, and causes the second display light to be emitted from the emission port via a second optical path having a second optical path-length longer than the first optical path-length to form the real image; a first controller that controls turning on and off of each of the first light sources; and a second controller that controls turning on and off of each of the second light sources, the method comprising:
performing, by the first controller, control such that the first light sources are turned-on more strongly than a predetermined intensity when the virtual image is to be displayed by the first display light; and
performing, by the second controller, control such that an area of the light sources to be turned-on more strongly than a predetermined intensity when the real image is to be displayed by the second display light is larger than an area of the light sources to be turned-on more strongly than the predetermined intensity when the virtual image is displayed.
